(19) United States
(12) Patent Application Publication
(10) Pub. No.: US 2024/0318488 A1
(43) Pub. Date: Sep. 26, 2024

(54) REFRIGERATOR

(71) Applicant: LG Electronics Inc., Seoul (KR)

(72) Inventors: Hee Jun LEE, Seoul (KR); Jinho CHANG, Seoul (KR); Jaehoon SHIN, Seoul (KR); Jae Un SHIN, Seoul (KR)

(73) Assignee: LG Electronics Inc., Seoul (KR)

(21) Appl. No.: 18/428,034

(22) Filed: Jan. 31, 2024

(30) Foreign Application Priority Data
Mar. 24, 2023 (KR) 10-2023-0038919

(51) Int. Cl. E05F 5/02

(52) U.S. Cl. CPC E05F 5/027; E05Y 2900/20; E05Y 2900/31

(57) ABSTRACT

A refrigerator includes a cabinet having a storage compartment, a door rotatably connected to the cabinet to open and close the storage compartment, and a damper configured to provide a damping force to resist the movement of door as the door rotates in a closing direction, the damping force including a first damping force having a first magnitude and a second damping force having a second magnitude that is less than the first magnitude.

### CROSS-REFERENCE TO RELATED APPLICATION

This application claims priority to and the benefit of Korean Patent Application No. 10-2023-0038919, filed on Mar. 24, 2023, the disclosure of which is incorporated herein by reference in its entirety.

### TECHNICAL FIELD

The present invention relates to a refrigerator, and in particular, a refrigerator provided with a door for opening and closing a storage compartment in which a storage target such as a food item and the like is stored.

### BACKGROUND

Refrigerators produce cold air, based on a circulation of refrigerants, and supply the cold air to a storage compartment, to keep a variety of storage targets fresh in the storage compartment for a long period of time.

A user can open and close a storage compartment formed in a main body of a refrigerator by using a door. As an example, the door may be embodied in different forms such as a rotary door that rotates around one side of the refrigerator, or a drawer door that is inserted and drawn in the front-rear direction.

The refrigerator is provided with a damper providing a damping force to the door. The damper may reduce a noise while absorbing an impact generated during opening and closing of the door.

Specifically, the damper provides a damping force to the door while the door is closed after the door is opened, to close the door smoothly and adjust the closing speed of the door.

For example, the damper may provide a damping force by using a resistant force caused by friction that is generated while a charging material such as oil or gas charging the damper passes through an orifice.

The movement of the charging material in the damper can be performed based on the reciprocation of a piston. The piston can move the charging material in the damper while reciprocating linearly in the cylinder in the damper.

Additionally, the refrigerator may be provided with a pillar. The pillar is provided to prevent the leakage of cold air in the storage compartment, and installed at one side of the door.

For example, a pair of doors is disposed at the refrigerator in the lateral direction, and opens the storage compartment while rotating in a direction where the pair of doors becomes far from each other. For example, a door disposed at the left side of the refrigerator may open and close of the left side of the storage compartment, while rotating around the end portion of the left side of the door, and a door disposed at the right side of the refrigerator may open and close the right side of the storage compartment, while rotating around the end portion of the right side of the door.

The pillar may be installed at any one of the pair of doors. Additionally, the pillar may be disposed between the pair of doors as the door is closed.

The pillar may rotate in such a way that the pillar is folded as the door is opened and unfolded as the door is closed. The pillar may be folded not to protrude in the lateral direction of the door as the door is opened, and unfolded to block a gap between the pair of doors as the door is closed.

An example of a damper installed at a refrigerator is disclosed in prior art document 1 (KR Patent Publication No. 10-2016-0102681).

Referring to FIGS. 35 and 36, the refrigerator of prior art document 1 comprises a hinge 80, a hinge cover and a damper.

The hinge 80 is provided to connect a cabinet 1 and a door 31 of the refrigerator and rotatably supports the door 31. The hinge 80 is installed at the cabinet 1. The hinge cover covers the hinge 80 and is coupled to the upper wall of the cabinet 1.

The damper comprises a damper apparatus 50 and a damper housing. In the damper, the damper apparatus 50 provides a damping function substantially. Additionally, the damper housing couples the damper apparatus 50 to the hinge cover.

The damper apparatus 50 comprises a cylinder 51, a piston 60, a press rod 61 and a damping fluid.

The piston 60 moves back and forth in the cylinder 51, and the damping fluid filling the inner space of the cylinder 51 provides a damping force to the piston 60 while being pressed slowly as the piston 60 moves.

The press rod 61 connects to the piston 60 and extends up to the outside of the piston 60. The press rod 61 is a portion that is directly pressed against the door 31 as the door 31 is closed.

As the door 31 is closed, the door 31 presses the press rod 61, to move the press rod 61, and accordingly, the press rod 61 presses the piston 60 while moving toward the inside of the cylinder 51.

The piston 60 presses the damping fluid in the cylinder 51, while being moved by the press rod 61. As described above, the damping fluid pressed by the piston 60 is slowly pressed, and accordingly, the damper apparatus 50 provides a damping force.

The door 31 comprises a thermal insulation material for thermally insulating the storage compartment, and a door guard storing a food item may be provided on the rear surface of the door 31. The door 31 weighs significantly because of food items stored in the door guard and the thermal insulation material.

Due to the weight of the door 31, a significant impact may be applied to the press rod 61 that directly contacts the door 31 as the door 31 is closed.

The door 31 may be provided with a press roller part 36. The press roller part 36 may press the press rod 61 gently as the door 31 is closed, and accordingly, an impact applied to the press rod 61 may decrease as the door 31 is closed.

In the refrigerator according to prior art document 1, a component such as a pillar is not provided.

The refrigerator without a pillar, in prior art document 1, is not provided with a structure capable of blocking between the pair of doors 31. Thus, the refrigerator of prior art document 1 cannot properly prevent cold air in a storage compartment from leaking.

Even if the pillar is applied to the refrigerator of prior art document 1, a resultant problem may be caused.

Ordinarily, the movement of the pillar may be induced by a cam structure installed at the cabinet 1 of the refrigerator. For example, the pillar may contact the cam structure installed at the cabinet 1 of the refrigerator as the door 31 is closed, and be unfolded by contacting the cam structure. Accordingly, as the pillar is unfolded, a significant amount of resistance caused due to contact between the pillar and the cam structure is applied to the door 31.

In particular, the movement of the pillar may occur at a timepoint when the door 31 is almost closed. That is, resistance caused by the movement of the pillar is applied to the door 31 at a latter half of the rotation of the door 31, performed to close the door 31.

The timing is a timing when a damping force provided by the damper is also applied to the door 31. Further, the rotation speed of the door 31 is reduced gradually by the damping force applied to the door 31, as the door 31 becomes closer to a position at which the door 31 is closed completely.

That is, in the case where the damper acts to the door 31 together with the pillar mounted on the door 31, the door 31 may not be closed properly due to a combined force of a resistant force of the pillar and a damping force of the damper.

At this time, if the damping force of the damper decreases, the damper produces a mere effect, and the door 31 may not be closed smoothly. Further, an excessively large impact is applied to the pillar and the cam structure while the door 31 is closed, and the pillar or the cam structure may be damaged easily.

### SUMMARY

### Technical Problems

One objective of the present invention is to provide a refrigerator having an improved structure in which a pillar and a damper are provided together such that the door is closed smoothly and securely.

Another objective of the present invention is to provide a refrigerator having an improved structure in which a door's quality feeling and performance of shielding a storage compartment are effectively improved.

Yet another objective of the present invention is to provide a refrigerator having an improved structure in which a pillar and its surround structures are less likely to be damaged.

### Technical Solutions

The invention is specified by the independent claim. Preferred embodiments are defined by the dependent claims. A refrigerator in one aspect comprises a damper providing a damping force resistant against a rotation of a door, and magnitude of the damping force provided by the damper changes as the door rotates.

In another aspect, a refrigerator comprises a damper that provides a first damping force or a second damping force less than the first damping force, while providing a damping force resistant against a rotation of the door, and as the door rotates, the damping force provided by the damper changes from the first damping force to the second damping force.

In another aspect, a refrigerator comprises a damper that operates based on at least any one of a first damping operation of providing a first damping force and a second damping operation of providing a second damping force less than the first damping force, and as the door rotates, the operation of the damper transitions from the first damping operation to the second damping operation.

In another aspect, a refrigerator comprises a cabinet configured to have a storage compartment, a door configured to rotate in a closing direction and to close the storage compartment, a damper configured to provide a damping force resistant against the rotation of the door in the closing direction, and a pillar unfolded as the door rotates in the closing direction and configured to provide a resistant force resistant against the rotation of the door in the closing direction, wherein a magnitude of the damping force provided by the damper changes as the door rotates.

In another aspect, a refrigerator comprises a cabinet configured to have a storage compartment, a door configured to rotate in a closing direction and close the storage compartment, a damper configured to provide a damping force resistant against the rotation of the door in the closing direction, and a pillar is unfolded as the door rotates in the closing direction and configured to provide a resistant force resistant against the rotation of the door in the closing direction, wherein a magnitude of the damping force provided by the damper changes with respect to a timepoint when the pillar is unfolded.

In another aspect, a refrigerator comprises a cabinet configured to have a storage compartment, a door configured to rotate in a closing direction and close the storage compartment, a damper configured to provide a damping force resistant against the rotation of the door in the closing direction and operate based on at least any one of a first damping operation of providing a first damping force and a second damping operation of providing a second damping force less than the first damping force, and a pillar is unfolded as the door rotates in the closing direction and configured to provide a resistant force resistant against the rotation of the door in the closing direction, wherein the operation of the damper starts with the first damping operation and then transitions to the second damping operation before the pillar is unfolded.

In another aspect, a refrigerator comprises a cabinet configured to have a storage compartment, a door configured to rotate in a closing direction and close the storage compartment, a damper configured to provide a damping force resistant against the rotation of the door in the closing direction, and a pillar is unfolded as the door rotates in the closing direction and configured to provide a resistant force resistant against the rotation of the door in the closing direction, wherein a magnitude of the damping force provided by the damper changes right before a timepoint when the pillar is unfolded.

In another aspect, a refrigerator comprises a cabinet configured to have a storage compartment, a door configured to rotate in a closing direction and close the storage compartment, a damper configured to provide a damping force resistant against the rotation of the door in the closing direction and provide a first damping force or a second damping force the magnitude of which is less than that of the first damping force, and a pillar is unfolded as the door rotates in the closing direction and configured to provide a resistant force resistant against the rotation of the door in the closing direction, wherein the pillar starts to be unfolded right after the damping force provided by the damper changes from the first damping force to the second damping force.

In another aspect, a refrigerator comprises a damper configured to provide a damping force resistant against the rotation of a door, wherein in a case where an angle formed by the front surface of a cabinet and the door is a set angle or less as the door rotates, magnitude of the damping force changes.

In another aspect, in a case where a refrigerator comprises a damper configured to provide a damping force resistant against the rotation of a door, wherein an angle formed by the front surface of a cabinet and the door is a set angle or less as the door rotates, magnitude of the damping force changes.

A refrigerator in one aspect may comprise a cabinet having a storage compartment; a door installed at the cabinet in such a way that the door is rotatable in a closing direction and in an open direction, and configured to rotate in the closing direction to close the storage compartment and to rotate in the opening direction to open the storage compartment; and a damper configured to provide a first damping force or a second damping force the magnitude of which is less than that of the first damping force, while providing a damping force resistant against the rotation of the door in the closing direction.

Preferably, as the door rotates in the closing direction, a damping force provided by the damper may change from the first damping force to the second damping force.

Preferably, the damper operates based on at least any one of a first damping operation of providing the first damping force and a second damping operation of providing the second damping force, and while the door rotates in the closing direction, the first damping operation and the second damping operation are performed consecutively.

Preferably, as the door rotates in the closing direction, the damping force provided by the damper changes from the first damping force to the second damping force, at a timepoint when an angle formed by a front surface of the cabinet and the door becomes a set angle or less.

Preferably, as the door rotates in the closing direction, the damping force provided by the damper changes from the first damping force to the second damping force, at a timepoint when a distance moved by the piston compressing fluid is a set distance or greater.

Preferably, as the door rotates in the closing direction, the damping force provided by the damper changes from the first damping force to the second damping force, at a timepoint when an angular speed of the door becomes a set speed or less.

Additionally, the refrigerator in the present invention may further comprise a pillar foldably installed at the door.

Preferably, the pillar is unfolded contacting the cabinet as the door closes the storage compartment, and the damping force provided by the damper changes from the first damping force to the second damping force, at a timepoint when the pillar contacts the cabinet or when the pillar is unfolded, as the door rotates in the closing direction.

Preferably, a magnitude of the second damping force is less than a magnitude of a third damping force that acts to the door as the pillar contacts the cabinet.

Preferably, a total of the magnitude of the third damping force that acts to the door as the pillar contacts the cabinet and magnitude of the second damping force is magnitude of the first damping force or less.

Preferably, the damper is installed at the door.

Further, the refrigerator in the present invention may further comprise a hinge assembly configured to rotatably connect the door to the cabinet.

Preferably, the damper generates a damping force while being pressed by the hinge assembly.

Preferably, the damper is pressed by the hinge assembly and generates a damping force while approaching toward the hinge assembly, and as the door rotates in the closing direction, the damper approaches toward the hinge assembly.

Preferably, the damper comprises a cylinder configured to accommodate fluid in an inner space thereof, and a piston configured to compress the fluid and to generate a damping force while moving in the inner space of the cylinder, and an operation of the damper transitions based on a change in a position of the piston.

Preferably, the inner space of the cylinder is divided into a first inner diameter section and a second inner diameter section.

Preferably, an inner diameter of the second inner diameter section is greater than an inner diameter of the first inner diameter section, and as the piston moves in the first inner diameter section, the damper operates based on the first damping operation, and as the piston moves in the second inner diameter section, the damper operates based on the second damping operation.

Preferably, the first inner diameter section and the second inner diameter section are arranged along a direction in which the piston moves, and as the door rotates in the closing direction, the piston moves from the first inner diameter section to the second inner diameter section, and as the piston moves from the first inner diameter section to the second inner diameter section, an operation of the damper transitions from the first damping operation to the second damping operation.

Preferably, as the door rotates in the closing direction, an operation of the damper transitions from the first damping operation to the second damping operation, in a case where an angle formed by a front surface of the cabinet and the door is a set angle or less.

Preferably, the damper operates based on the first damping operation in a first section that is a section between a point at which the damper starts to operate and a point at which the angle between the front surface of the cabinet and the door is the set angle, and operates based on the second damping operation in a second section that is a section between a point at which the door closes the storage compartment and the point at which the angle between the front surface of the cabinet and the door is the set angle.

Preferably, the pillar is unfolded while contacting the cabinet in the second section.

Preferably, the damper operates based on the first damping operation in a section where the angle formed by the front surface of the cabinet and the door is a first set angle or less and greater than a second set angle, and operates based on the second damping operation at a timepoint when the angle formed by the front surface of the cabinet and the door becomes the second set angle or less that is less than the first set angle.

Preferably, the pillar starts to be unfolded at a timepoint when the angle formed by the front surface of the cabinet and the door becomes a third set angle or less that is less than the second set angle.

Further, the first set angle α, the second set angle β and the third set angle γ satisfy a relationship such as β−γ«γ, β−γ«α−β

Further, as the door rotates in the closing direction, an operation of the damper transitions from a first damping operation to a second damping operation, in a case where a distance moved by the piston compressing fluid is a set distance or greater.

Preferably, the pillar is unfolded while contacting the cabinet in a case where the distance moved by the piston is the set distance or greater.

Preferably, the pillar is unfolded while contacting the cabinet in a case where an angular speed of the door is a set speed or greater.

A refrigerator in another aspect may comprise: a cabinet having a storage compartment; a pair of doors installed at the cabinet in such a way that the doors are rotatable in a closing direction and in an open direction, and configured to rotate in the closing direction to close the storage compartment and to rotate in the opening direction to open the storage compartment; a damper configured to operate based on at least any one of a first damping operation of providing a first damping force and a second damping operation of providing a second damping force magnitude of which is less than that of the first damping force, while providing a damping force resistance against the rotation of the door in the closing direction; and a pillar foldably installed at any one of the pair of doors, and unfolded while contacting the cabinet and configured to block between the storage compartment and the pair of doors as the door closes the storage compartment.

Preferably, as the door rotates in the closing direction, an operation of the damper transitions from the first damping operation to the second damping operation, in a set time range comprising a timepoint when the pillar contacts the cabinet or when the pillar is unfolded.

Preferably, the operation of the damper transitions from the first damping operation to the second damping operation before the timepoint when the pillar contacts the cabinet or when the pillar is unfolded.

Preferably, the damper operates based on the first damping operation by contacting the door rotating in the closing direction, and then operates based on the second damping operation before the timepoint when the pillar contacts the cabinet or when the pillar is unfolded.

Preferably, in a case where at least any one of a condition under which the angle formed by the front surface of the cabinet and the door is the set angle or less, a condition under which the angular speed is the set speed or less, and a condition under which the distance moved by the piston compressing fluid in the housing of the damper is the set distance or greater is satisfied, the operation of the damper transitions from the first damping operation and the second damping operation.

### Advantageous Effects

According to the present invention, a damper the damping force of which changes may be applied to a refrigerator provided with the damper and a pillar together, and the damper and the pillar may provide a sufficient damping force for opening and closing a door smoothly, such that the door is closed while the pillar is unfolded smoothly without stopping.

According to the present invention, the door may be closed securely and smoothly, at the refrigerator to which the pillar and the damper are applied together, and the pillar may be unfolded reliably.

According to the present invention, a resistant force of the pillar and a damping force of the damper may be applied to the door, such that a rotation speed of the door is controlled effectively, enabling the door to be closed smoothly, while the user closes the door properly without applying a force of large magnitude.

According to the present invention, the pillar may start to be unfolded at a timing when the rotation speed of the door starts to increase by changing the operation of the damper from a first damping operation to a second damping operation, such that the door rotates smoothly without stopping until the door is closed completely, while the pillar is unfolded more reliably.

According to the present invention, the door may be closed smoothly without stopping, at the refrigerator provided with the damper and the pillar together, and the pillar may be unfolded reliably, such that a quality feeling of the door and shielding performance of a storage compartment improve effectively.

According to the present invention, a damper assembly and the pillar provide a sufficient damping force required to close the door smoothly, such that an impact produced during closing of the door decreases to a minimum level, reducing the possibility of damage to the door and the pillar and their surrounding structures effectively.

### BRIEF DESCRIPTION OF DRAWINGS

The accompanying drawings constitute a part of the specification, illustrate one or more embodiments in the invention, and together with the specification, explain the invention, wherein:

FIG. 1 is a perspective view of a refrigerator of one embodiment;

FIG. 2 is a plan view of the refrigerator illustrated in FIG. 1;

FIG. 3 is a plan view of the refrigerator illustrated in FIG. 2 with a door open;

FIG. 4 is a planar cross-sectional view of a connection structure among a portion of the door illustrated in FIG. 3, a pillar and a cabinet;

FIG. 5 is a perspective view of the rear surface of a door separated from the refrigerator illustrated in FIG. 1;

FIG. 6 is an exploded perspective view of an exploded state of a damper assembly illustrated in FIG. 5;

FIG. 7 is a perspective view separately showing the damper assembly illustrated in FIG. 5;

FIG. 8 is an exploded perspective view of an exploded state of the damper assembly illustrated in FIG. 7;

FIG. 9 is a rear view of a damper cover illustrated in FIG. 8;

FIG. 10 is a front view of a damper case illustrated in FIG. 7;

FIG. 11 is a front view of the damper assembly illustrated in FIG. 7;

FIG. 12 is an exploded perspective view of an exploded state of a damper illustrated in FIG. 7;

FIG. 13 is a lateral cross-sectional view of the inner structure of the damper illustrated in FIG. 12;

FIGS. 14 and 15 are lateral cross-sectional views of a compressed state of the damper illustrated in FIG. 13;

FIGS. 16 and 17 are lateral cross-sectional views of a return state of the damper illustrated in FIG. 15;

FIG. 18 is a front cross-sectional view of a damper for showing an oil inflow path in the damper;

FIG. 19 is a view of an inlet of oil in a state where a ring contacts a first piston part;

FIG. 20 is a rear view of a piston illustrated in FIG. 19;

FIG. 21 is a side view of an outlet of oil in a state where a ring contacts a first piston part;

FIG. 22 is a front view of a piston illustrated in FIG. 21;

FIG. 23 is a lateral cross-sectional view of a damper for showing an oil flow path part in a state where a ring contacts a first piston part;

FIG. 24 is a side view of a return state of a damper;

FIG. 25 is a lateral cross-sectional view of the damper illustrated in FIG. 24;

FIG. 26 is a graph of a closing speed of a door without a damper;

FIG. 27 is a graph of a trend of changes in the closing speeds of a door with a damper which provides a damping force constantly;

FIG. 28 is a graph of a trend of changes in the closing speeds of a door with a damper comprising a section where a damping force changes;

FIG. 29 is a graph of a change in the damper compression distances, and a change in the damping forces based on a change in the door angles;

FIG. 30 is a planar cross-sectional view of a rotation state of a door at a damper contact timepoint;

FIG. 31 is a planar cross-sectional view of a rotation state of a door at a timepoint when a second set angle is reached;

FIG. 32 is a planar cross-sectional view of a rotation state of a door at a timepoint when a third set angle is reached;

FIG. 33 is a planar cross-sectional view of a door closed;

FIG. 34 is a graph of a change in the angular speeds based on each damper compression distance;

FIG. 35 is a cross-sectional view of a damper installation structure of a refrigerator based on a related art; and

FIG. 36 is a cross-sectional view of an inner structure of the damper illustrated in FIG. 35.

### DETAILED DESCRIPTION

The above-described aspects, features and advantages are specifically described hereafter with reference to accompanying drawings such that one having ordinary skill in the art to which the invention pertains can embody the technical scope of the invention easily. In the invention, detailed description of known technologies in relation to the subject matter of the invention is omitted if it is deemed to make the gist of the invention unnecessarily vague Hereafter, preferred embodiments according to the invention are specifically described with reference to the accompanying drawings. In the drawings, identical reference numerals can denote identical or similar components.

The terms “first”, “second” and the like are used herein only to distinguish one component from another component. Thus, the components are not to be limited by the terms. Certainly, a first component can be a second component, unless stated to the contrary.

Embodiments are not limited to the embodiments set forth herein, and can be modified and changed in various different forms. The embodiments in the invention are provided such that the invention can be through and complete and fully convey its scope to one having ordinary skill in the art. Accordingly, all modifications, or replacements as well as a replacement of the configuration of any one embodiment with the configuration of another embodiment or an addition of the configuration of any one embodiment to the configuration of another embodiment, within the technical scope of the invention, are to be included in the scope of the invention.

The accompanying drawings are provided for a better understanding of the embodiments set forth herein and are not intended to limit the technical scope of the invention. It is to be understood that all the modifications, or replacements within the technical scope of the invention are included in the scope of the invention. The sizes or thicknesses of the components in the drawings are exaggerated or reduced to ensure case of understanding and the like. However, the protection scope of the subject matter of the invention is not to be interpreted in a limited way.

The terms in the invention are used only to describe specific embodiments or examples and not intended to limit the subject matter of the invention. In the invention, singular forms include plural forms as well, unless explicitly indicated otherwise. In the invention, the terms “comprise”, “comprised of” and the like specify the presence of stated features, integers, steps, operations, elements, components or combinations thereof but do not imply the exclusion of the presence or addition of one or more other features, integers, steps, operations, elements, components or combinations thereof.

The terms “first”, “second” and the like are used herein only to distinguish one component from another component, and the components are not to be limited by the terms.

When any one component is described as “connected” or “coupled” to another component, any one component can be directly connected or coupled to another component, but an additional component can be “interposed” between the two components or the two components can be “connected” or “coupled” by an additional component. When any one component is described as “directly connected” or “directly coupled” to another component, an additional component cannot be “interposed” between the two components or the two components cannot be “connected” or “coupled” by an additional component.

When any one component is described as being “on (or under)” another component, any one component can be directly on (or under) another component, and an additional component can be interposed between the two components.

Unless otherwise defined, all the terms including technical or scientific terms used herein have the same meaning as commonly understood by one having ordinary skill in the art. Additionally, terms such as those defined in commonly used dictionaries are to be interpreted as having a meaning that is consistent with their meaning in the context of the relevant art, and unless explicitly defined herein, are not to be interpreted in an ideal way or an overly formal way.

In the state where a refrigerator stands on the floor, a direction in which a door is installed with respect to the center of the refrigerator is defined as a forward direction. Accordingly, a direction toward the inside of the refrigerator with the door open is defined as a rearward direction. For convenience, the forward direction and the rearward direction can be referred to as a first direction. Then the forward direction is referred to as one direction of the first direction, and the rearward direction is referred to as the other direction of the first direction.

Additionally, a gravitational direction can be defined as a downward direction, and a direction opposite to the gravitational direction can be defined as an upward direction.

Further, a horizontal direction across a front-rear direction of the refrigerator, i.e., a widthwise direction of the refrigerator that is seen in front of the door of the refrigerator, can be referred to as a left-right direction. For convenience, the left-right direction can be referred to as a second direction. Then the right side can be referred to as one direction of the second direction, and the left side can be referred to as the other direction of the second direction.

Further, the widthwise direction of the refrigerator can also be referred to as a lateral direction. Then the right side can also be referred to as one side of the lateral direction, and the left side can be referred to the other side of the lateral direction.

Additionally, an up-down direction can be referred to as a third direction. Then an upward direction can be referred to as one direction of the third direction, and a downward direction can be referred to as the other direction of the third direction.

Furthermore, the up-down direction can be referred to as a vertical direction. Then the front-rear direction and the left-right direction, i.e., the first direction and the second direction, can be referred to as the horizontal direction.

Throughout the invention, the terms “A and/or B” as used herein can denote A, B or A and B, and the terms “C to D” can denote C or greater and D or less, unless stated to the contrary. [Entire structure of refrigerator]

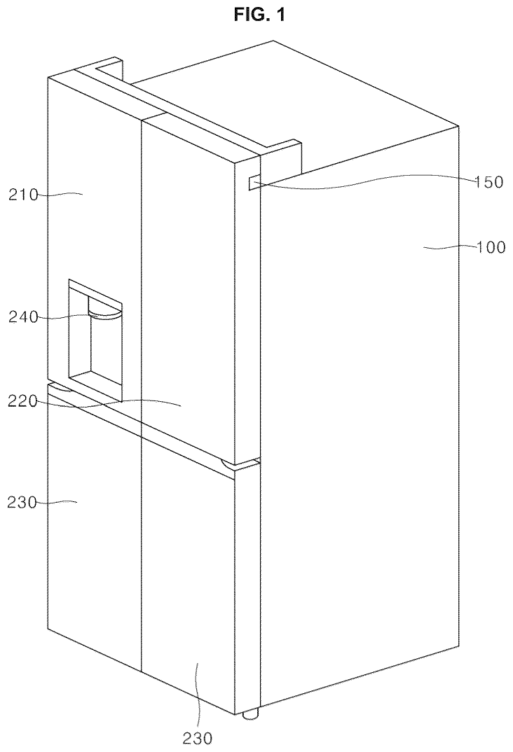

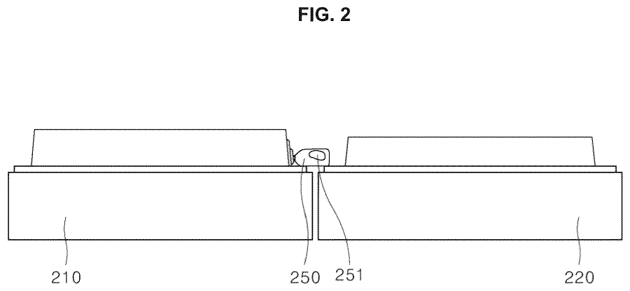

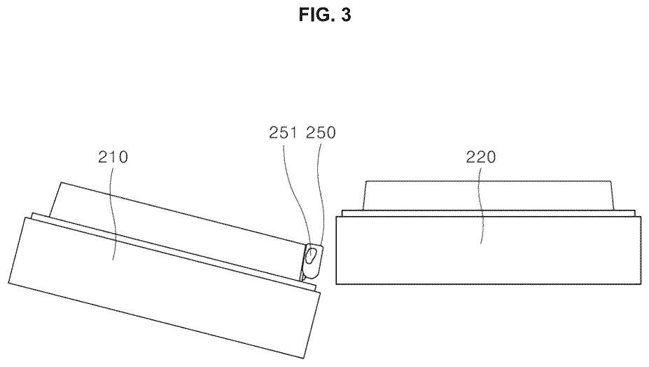

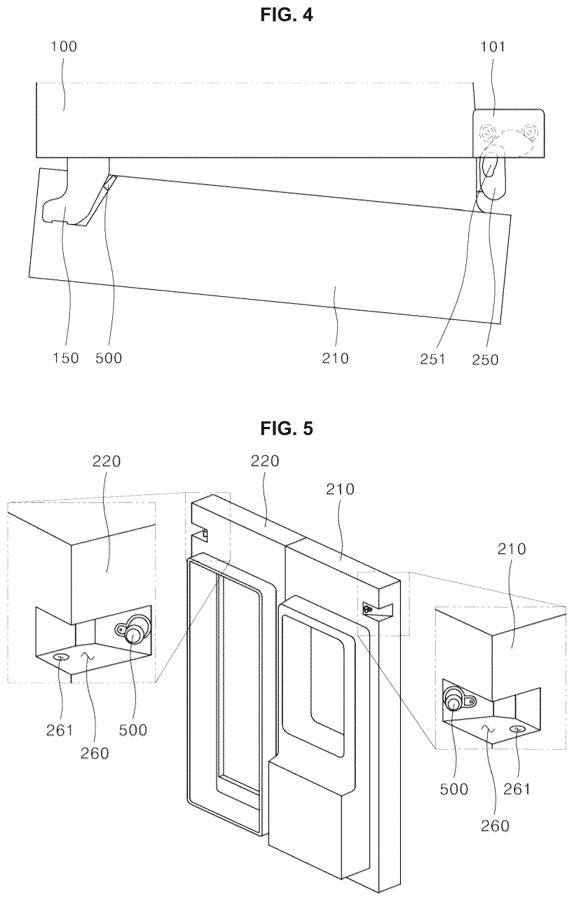

FIG. 1 is a perspective view of a refrigerator of one embodiment, and FIG. 2 is a plan view of the refrigerator illustrated in FIG. 1. FIG. 3 is a plan view of the refrigerator illustrated in FIG. 2 with a door open, and FIG. 4 is a planar cross-sectional view of a connection structure among a portion of the door illustrated in FIG. 3, a pillar and a cabinet.

Referring to FIGS. 1 and 2, the exterior of a refrigerator 1 may be formed by a cabinet 100 and a door 210, 220, 230.

The cabinet 100 may have one or more of storage compartments therein, as a storage space of the refrigerator 1. An open front surface of the cabinet 100 may be opened and closed by one or more of doors 210, 220, 230.

The cabinet 100 may comprise an outer case, and an inner case coupled to the inside of the outer case.

The cabinet 100 may be shaped into a box the front surface of which is open. The inner portion of the cabinet 100 may be divided into one or more of storage spaces, and comprise a refrigerator compartment and/or a freezer compartment.

For example, an upper storage compartment opened and closed by a pair of upper doors 210, 220 may be provided in the upper portion of the cabinet 100. Additionally, a lower storage compartment opened and closed by a pair of lower doors 230 may be provided in the lower portion of the cabinet 100.

In the embodiment, a bottom freeze refrigerator is described as an example, and the bottom freeze refrigerator has a refrigerator compartment in the upper portion thereof and has a freezer compartment in the lower portion thereof, as storage compartments in the cabinet 100.

However, the subject matter of the present invention is not limited to the above-described refrigerator, and may comprise various types of refrigerators such as a top freezer refrigerator in which a freezer compartment is mounted on a refrigerator compartment, and a side-by-side refrigerator in which a freezer compartment and a refrigerator compartment are partitioned at the left/right side, and the like.

The door 210, 220, 230 may comprise an upper door 210, 220 and a lower door 230. That is, for the refrigerator of the embodiment, a door 210, 220 for opening and closing the upper storage compartment and a door 230 for opening and closing the lower storage compartment may be provided separately. Further, the door 210, 220 for opening and closing the upper storage compartment and the door 230 for opening and closing the lower storage compartment may be provided in such a way that the doors are divided into a left door and a right door.

However, the subject matter of the present invention may not be limited and may comprise refrigerators provided with various types of doors such as a refrigerator provided with one door for opening and closing a freezer compartment and one door for opening and closing a refrigerator compartment, a refrigerator provided with any one of a door for opening and closing a freezer compartment and a door for opening and closing a refrigerator compartment in such a way that any one door is divided into a left door and a right door, a refrigerator provided with a door for opening and closing a freezer compartment and a door for opening and closing a refrigerator compartment in such a way that the doors are rotatably mounted, a refrigerator provided with a door for opening and closing a freezer compartment and a door for opening and closing a refrigerator compartment in such a way that any one of the doors is mounted to be drawn in the front-rear direction, and the like.

As an example, a first door 210 and a second door 220, as a pair of upper doors 210, 220, may be rotary doors that are rotatably coupled to a pair of hinge assemblies 150 installed respectively at both sides of the cabinet 100. The pair of upper doors 210, 220 may be divided into a first door 210 at the left side of the cabinet, and a second door 220 at the right side of the cabinet.

The pair of upper doors 210, 220, as described above, may open the storage compartment by rotating in a direction where the pair of upper doors 210, 220 becomes far away from each other, while respectively rotating in the lateral direction. For example, the first door 210 disposed at the left side of the refrigerator may open and close the left side of the storage compartment, while rotating around the left end portion of the refrigerator, and the second door 220 disposed at the right side of the refrigerator may open and close the right side of the storage compartment while rotating around the right end portion of the refrigerator.

Additionally, the lower door 230 may also be a rotary door, but not limited. As another example, the lower door 230 may be a drawer door that opens and closes the storage compartment in a sliding manner.

Further, a dispenser 240 may be mounted on any one of the first door 210 and the second door 220. The dispenser 240 may be provided to allow the user to take out drinking water and ice outside the storage compartment of the refrigerator.

In the bottom freezer refrigerator, the upper storage compartment and the lower storage compartment may be divided by a horizontal separation wall disposed between the upper storage compartment and the lower storage compartment. Further, a left space and a right space in the lower storage compartment may be divided by a perpendicular separation wall disposed in the lower storage compartment.

The left space of the lower storage compartment may be opened and closed by the lower door 230 disposed at the left side of the lower storage compartment, and the right space of the lower storage compartment may be opened and closed by the lower door 230 disposed at the right side of the lower storage compartment. That is, the lower door 230 may be provided in such a way that the lower door 230 opens and closes each independent storage space individually.

In the bottom freezer refrigerator, a perpendicular separation wall may not be disposed in the upper storage compartment. That is, in the bottom freezer refrigerator, the left space and the right space in the upper storage compartment may connect as one space without separating into separate spaces.

Since the left space and the right space in the upper storage compartment connect as one space as described above, the upper storage compartment may provide a storage space having a wide entrance and large volume.

However, unless a perpendicular separation wall is not disposed in the upper storage compartment, the airtight performance of the refrigerator may deteriorate while a portion of the upper door 210, 220 does not contact the front surface of the cabinet 100.

For example, in the case where a perpendicular separation wall is disposed in the upper storage compartment, cold air may leak through a gap between the first door 210 and the second door 229 that are blocked by the perpendicular separation wall.

Considering this, a pillar 250 may be installed at the upper door 210, 220. In this embodiment, the pillar 250 is installed at the first door 210, for example.

The pillar 15 may be installed in a lateral portion of the first door 210, specifically, at one side of the first door 210, which faces the second door 220. The pillar 250 may be provided in such a way that the pillar extends in the up-down direction along one side of the first door 210.

The pillar 250, as illustrated in FIG. 2, may remain unfolded in a state where the first door 210 is closed. The unfolded pillar 250 may be disposed between the front surface of the cabinet 100 and the upper door 210, 220 to block a gap between the front surface of the cabinet 100 and the upper door 210, 220 and block a gap between the first door 210 and the second door 220.

The pillar 250, which is unfolded with the upper door 210, 220 closed and blocks a gap between the first door 210 and the second door 220 as described above, may prevent cold air from leaking through the gap between the upper doors 210, 220.

As the first door 210 is opened, the pillar 250 may rotate to be folded toward one side of the first door 210 (see FIG. 3). As the first door 210 is closed, the pillar 250 may rotate to be unfolded (see FIG. 2).

The pillar 250, as illustrated in FIG. 4, may rotate based on an interaction between a cam of a pillar rotation member 101 installed at the upper end of the cabinet 100 and a pillar cam 251 formed at the upper end of the pillar 250.

As an example, as the first door 210 is closed, the pillar cam 251 moving in the pillar rotation member 101 and the cam of the pillar rotation member 101 may contact each other, and the cam of the pillar rotation member 101, contacting the pillar cam 251, may change a path in which the pillar cam 251 moves.

For example, a direction in which the pillar cam 251, moving in the same direction as the direction in which the first door 210 rotates, moves may change in a direction close to the lateral direction, because of contact between the pillar cam 251 and the cam of the pillar rotation member 101.

That is, the path in which the pillar cam 251 moving in the pillar rotation member 101 moves may be shaped into “T” by the cam of the pillar rotation member 101. The pillar 250 may be rotated to be unfolded, by the pillar cam 251 moving in the above-described movement path.

On the contrary, as the first door 210 is opened, the movement direction of the pillar cam 251 may change to the same direction as the rotation direction of the first door 210 from the lateral direction. Accordingly, the pillar 250 may be rotated to be folded by the pillar cam 251 moving as described above.

Further, as the door 210, 220, 230 is closed, the door 210, 220, 230 collides with the cabinet 100. As such a collision occurs, the door 210, 220, 230 bounces, and as the magnitude of a collision increases, the door 210, 220, 230 bounces further.

As the first door 210 is closed, the pillar 250 acts as resistance and provides resistance to the first door 210. However, resistance provided by the pillar 250 is not enough to suppress a bounce that occurs as the first door 210 is closed.

Considering this, the refrigerator 1, as illustrated in FIGS. 1 and 4, may be provided with a damper assembly 500 that provides a damping force to the first door 210.

The damper assembly 500 may help to close the first door 210 smoothly and reduce a bounce of the first door 210, by providing a damping force to the first door 210, while the first door 210 is closed.

Further, since the pillar 250 is not mounted on the second door 220, the damper assembly 500 may be provided at the second door 220 to suppress a bounce of the second door 220.

The damper assembly 500 may be mounted on the door 210, 220, 230, or in the cabinet 100 or another component of the refrigerator 1, to collide with the door 210, 220, 230.

In this embodiment, the structure and operation of the damper assembly 500 are described with reference to a damper assembly 500 mounted on the first door 210, for example.

### [Installation Structure of Damper Assembly]

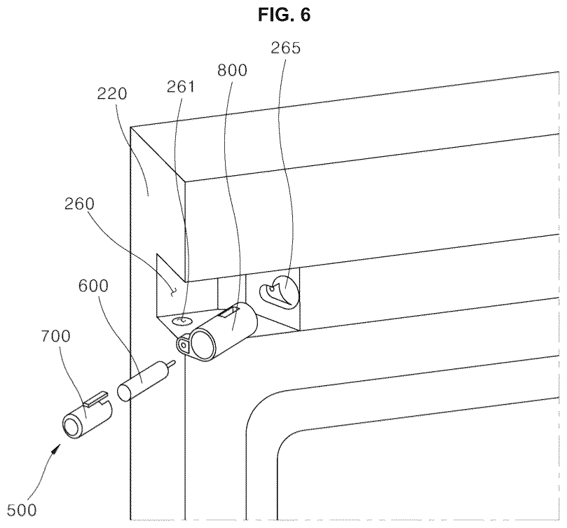

FIG. 5 is a perspective view of the rear surface of a door separated from the refrigerator illustrated in FIG. 1, and FIG. 6 is an exploded perspective view of an exploded state of a damper assembly illustrated in FIG. 5.

Referring to FIGS. 4 to 6, the first door 210 and the second door 220 may have a hinge mounting space 260 respectively. The hinge mounting space 260 may be disposed respectively at one side of the upper area of the first door 210 and at one side of the upper area of the second door 220, while being formed respectively on the rear surface of the first door 210 and the rear surface of the second door 220.

The hinge assembly 150 may be inserted into a hinge mounting space 260. Additionally, a hinge mounting part 261 may be formed in each hinge mounting space 260. The hinge assembly 150 may be mounted on the hinge mounting part 261 and provide a rotation axis for rotation of the first door 210 or the second door 220.

The hinge mounting space 260 may be disposed at a position near a lateral surface of the cabinet 100, and may be large enough for the hinge assembly 150 to be inserted and operate.

In the embodiment, the damper assembly 500 is installed at the first door 210 and the second door 220 respectively, for example. Hereinafter, the installation structure of the damper assembly 500 is described with reference to a damper assembly 500 installed at the first door 210, for example. However, particulars in relation to this may be applied to a damper assembly 500 installed at the second door 220, in the same way.

In this embodiment, the damper assembly 500 may be installed in the hinge mounting space 260. To this end, a damper assembly mounting part 265 may be formed in the hinge mounting space 260.

The damper assembly mounting part 265 may form a space into which at least a portion of the damper assembly 500 is inserted, in the first door 210. The damper assembly mounting part 265 may be depressed in the horizontal direction toward the inside of the first door 210, in the hinge mounting space 260.

The damper assembly 500 may be inserted into the damper assembly mounting part 265 in the horizontal direction, and fixed to the first door 210. The damper assembly mounting part 265 may be depressed in a direction facing between one side and the front surface of the first door 210, i.e., in a diagonal direction, while being depressed toward the inside of the first door 210.

The damper assembly 500 mounted on the damper assembly mounting part 265 formed as described above may be disposed in the diagonal direction parallel with the direction in which the damper assembly mounting part 265 is depressed, while being disposed on the first door 210 in the horizontal direction.

The damper assembly 500 disposed as described above may protrude in a direction between the front surface and a lateral surface of the cabinet 100, while protruding rearward from the first door 210. That is, the damper assembly 500 mounted on the first door 210 may protrude toward an edge side connecting between the front surface and a lateral surface of the cabinet 100.

The hinge assembly 150 disposed at an edge side connecting between the front surface and a lateral surface of the cabinet 100, the front surface of the cabinet 100, or one of a variety of components constituting the refrigerator 1 may be a counterpart structure contacting the damper assembly 500 mounted on the first door 210.

In this embodiment, the damper assembly 500 generates a damping force by contacting the hinge assembly 250, for example.

Based on contact between the damper assembly 500 and the hinge assembly 150, a portion of the damper assembly 500 moves, and accordingly, the damper assembly 500 generates a damping force.

The damper assembly 500 may be installed obliquely at the first door 210 that is a structure making a rotation. That is, the damper assembly 500 may be installed obliquely installed at the first door 210, in such a way that a movement axis of the damper assembly 500 is disposed obliquely. The damper assembly 500 obliquely installed as described above may generate a damping force while contacting the hinge assembly 150 disposed in a lateral portion of the first door 210.

At this time, a force applied based on rotation of the first door 210, i.e., a force acting in a direction parallel with the rotation direction of the first door 210, may be applied to the damper assembly 500. Thus, a force acting in the front-rear direction is applied to the damper assembly 500 because of a force acting in the above-described direction.

The force applied in the front-rear direction, as described above, is applied as a force in a direction across the movement axis of the damper assembly 500. Accordingly, a side force acting in the lateral direction of the damper assembly 500 as well as a force applied in the lengthwise direction of the damper assembly 500 may be applied to the damper assembly 500.

In particular, in the case where the damper assembly 500 is installed in the hinge mounting space 260, the damper assembly 500 is disposed in a relatively small radius of gyration at a time of rotation of the first door 210 and the second door 220. Accordingly, a greater side force may be applied to the damper assembly 500.

Considering this, the damper assembly 500 in this embodiment may further comprise a damper cover 700 and a damper case 800 as well as the damper 600.

The damper cover 700 and the damper case 800 may protect the damper 600 from a side force applied to the damper assembly 500, not to damage the damper 600 and assist with the movement of the damper 600 to ensure a smooth linear movement of the damper assembly 500.

A detailed structure and operation of the damper assembly 500 comprising the damper cover 700 and the damper case 800 are described hereinafter.

### [Schematic Structure of Damper Assembly]

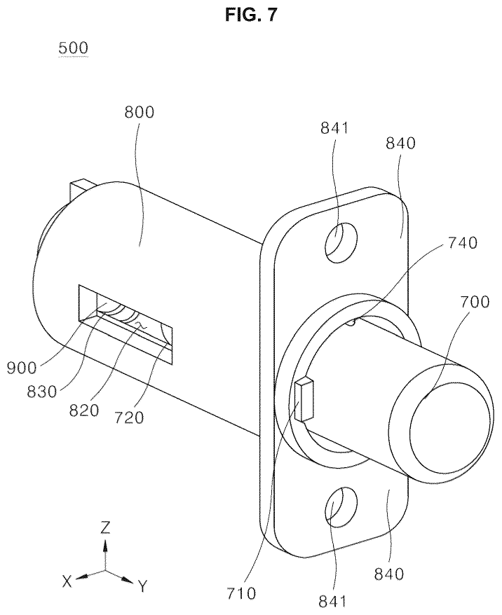

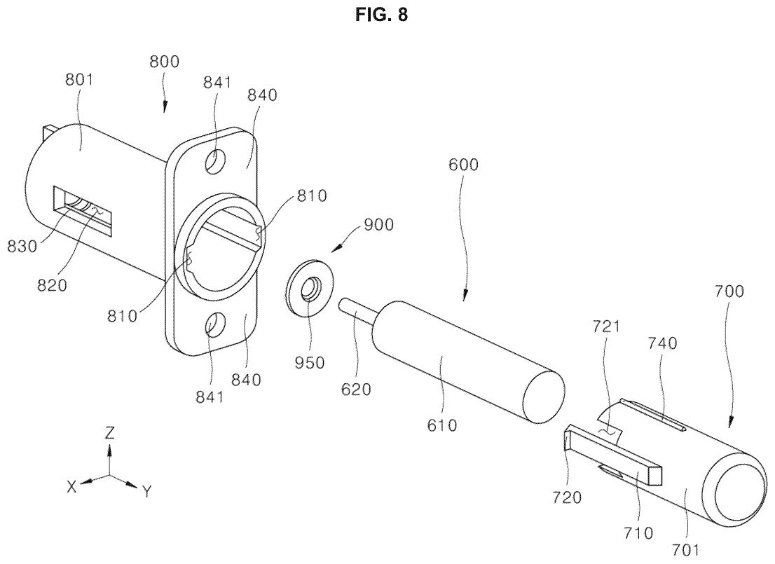

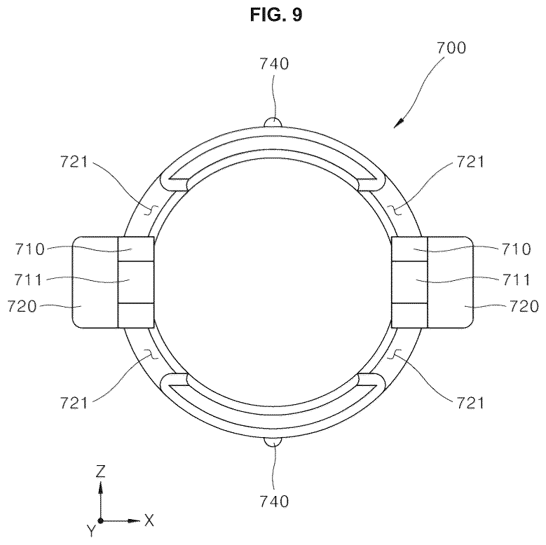

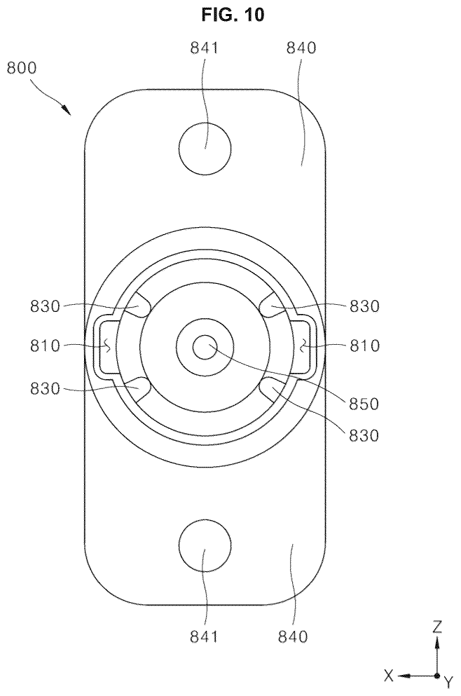

FIG. 7 is a perspective view separately showing the damper assembly illustrated in FIG. 5, and FIG. 8 is an exploded perspective view of an exploded state of the damper assembly illustrated in FIG. 7, and FIG. 9 is a rear view of a damper cover illustrated in FIG. 8. Additionally, FIG. 10 is a front view of a damper case illustrated in FIG. 7.

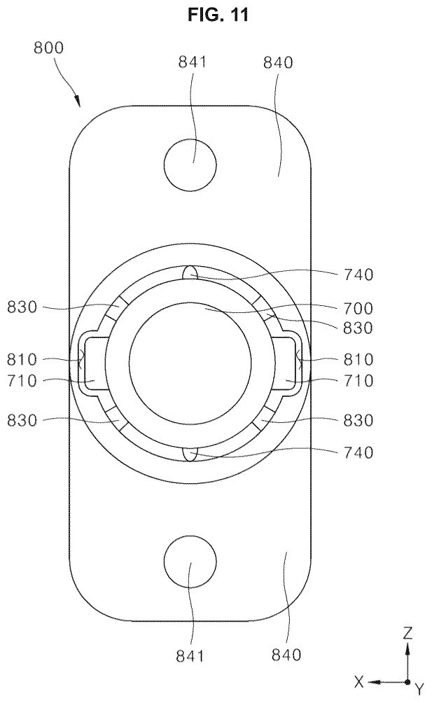

Hereinafter, the structure of the damper assembly 500 in this embodiment is briefly described with reference to FIGS. 7 to 11.

The front-rear direction of the damper assembly 500 described in the present invention may be a direction along the Y-axis, as illustrated in FIG. 7, the up-down direction may be a direction along the Z-axis, and the left-right direction may be the X-axis.

The damper assembly 500 may comprise a damper 600. The damper 600 may substantially perform a damping function at the damper assembly 500. The damper 600 may comprise a housing 610 forming the exterior of the damper 600.

As an example, the housing 610 may be shaped into a cylinder the rear end portion of which is open. A space capable of accommodating various types of components constituting the damper 600 may be formed in the housing 610 provided as described above.

The damper 600 may further comprise a rod 620. The rod 620 may be provided to protrude from the rear end portion of the housing 610.

As an example, the rod 620 may be shaped into a cylindrical rod that extends in the lengthwise direction of the damper 600. The rod 620 may be inserted into the housing 610 through the open rear end portion of the housing 610 and reciprocate along the lengthwise direction of the housing 610.

A piston 670 may be fixed to one side of the rod 620 and placed in the housing 610, and a partial area of the other side of the rod 620 may protrude from the rear end portion of the housing 610.

The piston 670 is specifically described hereinafter.

Since the diameter of the rod 620 is much less than that of the housing 610, that is, the thickness of the rod 620 is not that great, the rod 620 may be easily bent or damaged, making it difficult for the damper 600 to operate properly, in the case where a side force is applied to the damper 600.

Considering this, the damper assembly 500 may further comprise a damper cover 700 and a damper case 800 that are provided to protect the damper 600.

The damper cover 700 may surround the front end portion of the damper 600 and at least a partial area of the outer circumferential surface of the damper 600. Additionally, the damper case 800 may surround the rear end portion of the damper 600 and at least a partial area of the outer circumferential surface of the damper 600.

### [Structure of Damper Cover and Structure of Damper Case]

The damper cover 700 may comprise a cover body 701. As an example, the cover body 701 may be shaped into a cylinder the rear end portion of which is open.

A partial area of the damper 600, comprising the front end portion of the damper 600, may be inserted into the cover body 701 through the open rear end portion of the cover body 701. The front end portion of the damper 600, inserted into the cover 700 as described above, may contact the rear surface of the front end portion of the body 701, in the cover 701.

To this end, the inner diameter of the cover body 701 may be greater than the outer diameter of the housing 610.

The cover body 701 may comprise a pair of rail parts 710 that extends in the front-rear direction.

The pair of rail parts 710 may respectively protrude from the outer surface of the cover body 701 outward, to have a predetermined thickness. The pair of rail parts 710 may be disposed respectively at the left and right sides of the outer surface of the cover body 701, to face each other.

The rear end portion of the rail part 710 may protrude further rearward than the rear end portion of the cover body 701. Additionally, the rail part 710 may have a holding part 720, at the rear end portion of the rail part 710.

The holding part 720 may be shaped into a hook. The holding part 720 may restrict the movement of the damper cover 700, based on a hook coupling with the damper case 800, in the case where the damper cover 700 is inserted into the damper case 800.

For example, the front end portion of the holding part 720 may protrude further outward than the rail part 710, to form a step between the front end portion of the holding part 720 and the rail part 710. The front end portion of the holding part 720, formed as described above, may be hook-coupled to a slit part 820 of the damper case 800.

The slit part 820 of the damper case 800 may be additionally described hereinafter.

The rear end portion of the holding part 720 may comprise an inclination surface that slopes downward toward the rear of the holding part 720. The rear end portion of the holding part 720, formed as described above, may guide the damper cover 700 such that the damper cover 700 is easily inserted into the damper case 800.

Additionally, the pair of rail parts 710 may be elastically deformable. For example, the pair of rail parts 710 may be made of an elastic material that may slightly bend in a direction where the pair of rail parts 710 faces each other and then return to an original state. The pair of rail parts 710 provided as described above may help the damper cover 700 to be easily inserted into the damper case 800.

The rail part 710 may have a reinforcement part 711, on the inner surface thereof. The reinforcement part 711 may be formed to extend along the direction where the rail part 710 extends, in the front-rear direction, and reinforce the strength of the rail part 710.

A plurality of insertion parts 721 may be provided on the outer surface of the cover body 701. Each insertion part 721 may be formed at the cover body 701 in such a way that the insertion part 721 is open.

For example, the insertion part 721 may be formed in such a way that a partial area is open from the rear end portion of the cover body 701 to the front thereof. The front end portion of the insertion part 721 may be disposed further forward than the rear end portion of the cover body 701. With respect to one rail part 710, a pair of insertion parts 721 may be respectively disposed at both sides of the rail part 710.

The damper cover 700 may further comprise a first guide rib 740. The first guide rib 740 may protrude from the outer surface of the cover body 701 in the front-rear direction.

A pair of first guide ribs 740 may be disposed on the outer surface of the upper portion of the cover body 701 and on the outer surface of the lower portion of the cover body 701. That is, any one of the pair of first guide ribs 740 may be disposed on the outer surface of the upper portion of the cover body 701, and the other may be disposed on the outer surface of the lower portion of the cover body 701.

Each of the first guide ribs 740 may extend up to a predetermined position in the front-rear direction, in a narrow and long shape, while extending from the rear end portion of the cover body 701 forward.

The first guide rib 740 may operate to prevent the entire outer circumferential surface of the cover body 701 from contacting the inner circumferential surface of the damper case 800, as the damper cover 700 is inserted into the damper case 800 and reciprocates in the front-rear direction.

The first guide rib 740 may guide the reciprocation of the damper cover 700 while decreasing friction that may occur between the cover body 701 of the damper cover 700 and the inner circumferential surface of the damper case 800.

The damper case 800 may be coupled to the damper cover 700, while surrounding at least a partial area of the rear end portion of the damper 600 and at least a partial area of the outer circumferential surface of the damper 600. The damper case 800 may comprise a case body 801.

As an example, the case body 801 may be shaped into a cylinder the front end portion of which is open. A partial area of the damper 600, comprising the rear end portion of the damper 600, may be inserted into the case body 801 through the open front end portion of the case body 801. The rod 620 of the damper 600 inserted into the damper case 800 may be supported by the front surface of the rear end portion of the case body 801, in the case body 801.

To this end, the inner diameter of the case body 801 may be greater than the outer diameter of the housing 610.

The case body 801 may have a case groove 850. The case groove 850 may be formed on the front surface of the rear end portion of the case body 801, in such a way that the case groove 850 is concavely depressed. As an example, the case groove 850 may be shaped into a circle corresponding to the shape of the cross section of the rod 620.

The case groove 850, formed as described above, may effectively restrict a movement of the rod 620 in another direction, i.e., a shake of the rod 620 in the up-down and left-right directions, in addition to a movement of the rod 620 in the front-rear direction as well as guiding a coupling position of the rod 620 relative to the case body 801.

Since the damper 600 is inserted into the damper case 800, in the state of being inserted into the damper cover 700, the case body 801 and the housing 610 of the damper 600 may not contact each other directly. The inner circumferential surface of the case body 801 and the outer circumferential surface of the cover body 701 may contact each other directly.

To this end, the inner diameter of the case body 801 may be greater than the outer diameter of the housing 610 and the outer diameter of the cover body 701.

A pair of guide parts 810 may be provided on the inner surface of the case body 801. The pair of guide parts 810 may be provided to guide the movement of the pair of rail parts 710 of the damper cover 700.

The guide part 810 may be formed in such a way that the guide part 810 is depressed from the inner circumferential surface of the case body 801 toward the outer circumferential surface of the case body 801. Preferably, the guide part 810 may be concavely formed on the inner circumferential surface of the case body 801, to have a depth corresponding to the thickness of the rail part 710. The guide part 810 may be formed in such a way that the guide part 810 extends from the front end portion of the case body 801 rearward.

A pair of guide parts 810 may be disposed at both sides of the inner surface of the case body 801, to face each other. Each of the rail parts 710 may be inserted into each of the guide parts 810 in a sliding manner. As described above, the rail part 710 inserted into the damper case 800 through the guide part 810 may reciprocate along the guide part 810 in the front-rear direction.

A pair of slit parts 820 may be provided on the lateral surface of the case body 801. The pair of slit parts 820 may be formed in such a way that the slit part 820 penetrates the case body 801 in the lateral direction. Each of the slit parts 820 may be disposed to overlap a partial area of the guide part 810, and disposed in an area that is eccentric rearward from the center of the case body 801 in the front-rear direction.

The holding part 720 of the damper cover 700 may be inserted into the slit part 820 and reciprocate along the slit part 820 in the front-rear direction. Accordingly, the damper cover 700 may be coupled to the damper case 800 in such a way that the damper cover 700 reciprocates in the front-rear direction. Additionally, the damper 600 may be compressed or extended in the front-rear direction together with the front end portion of the damper cover 700 reciprocating as described above.

In the case where the damper 600 extends to a maximum degree, the front end portion of the holding part 720 of the damper cover 700 may be limited by the front end portion of the slit part 820 that is open. Accordingly, an additional movement of the holding part 720 may be limited, and a maximum extension distance of the damper 600 may be controlled to prevent an excessive extension of the damper 600.

A plurality of second guide ribs 830 may be provided on the inner surface of the case body 801. Each of the second guide ribs 830 may protrude from the inner surface of the case body 801 inward, and extend along the front-rear direction.

Each of the second guide ribs 830 may have a width less than that of the first guide rib 810 or the slit part 820, while extending from the rear end portion of the case body 801 forward.

The second guide rib 830 may be formed in such a way that the front end portion of the second guide rib 830 is disposed further rearward than the front end portion of the slit part 820.

In this embodiment, a pair of second guide ribs 830 is disposed respectively on the inner surface of the upper portion of the slit part 820 and the inner surface of the lower portion of the slit part 820, for example. Accordingly, the second guide rib 830 may be respectively disposed at both sides of each slit part 820 in the up-down direction thereof.

The plurality of second guide ribs 830 disposed as described above may reinforce the strength of the case body 801, which is weakened by the slit part 820 that is formed at the case body 801 in such a way that the slit part 820 is open.

Further, the second guide rib 830 may guide the movement of the damper cover 700 inserted into the damper case 800. That is, the second guide rib 830 may guide the movement of the damper cover 700 in such a way that the insertion part 721 of the damper cover 700 reciprocates along the second guide rib 830.

In the case where the damper cover 700 extends, the second guide rib 830 is not inserted into the insertion part 721, but in the case where the damper cover 700 is compressed, a partial area of the second guide rib 830 comprising the front end portion of the second guide rib 830 may be inserted into the insertion part 721.

As a partial area of the second guide rib 830 is inserted into the insertion part 721 as described above, the damper cover 700 may movably engage with the second guide rib 830, and the second guide rib 830 may guide the movement of the damper cover 700.

The case body 801 may further comprise at least one of fastening parts 840. The fastening part 840 may protrude from the outer circumferential surface of the case body 801 outward.

As an example, a pair of fastening parts 840 may be provided at the case body 801, and any one of the pair of fastening parts 840 may protrude to the upper side of the case body 801, and the other may extend to the lower side of the case body 801.

Each fastening part 840 may have a fastening hole 341, and each fastening hole 341 may be formed in such a way that the fastening hole 341 penetrates the fastening part 840 in the front-rear direction.

In the case where the damper assembly 500 is coupled to a fixation target, a fastening member such as a screw may fix the fastening part 840 to the fixation target while passing through the fastening part 840 through the fastening hole 341.

The fastening part 840 may be disposed at a position near the open front end portion of the case body 801. Accordingly, at the case body 801, the size of an area at the front side of the fastening part 840 may be much less than the size of an area at the rear side of the fastening part 840.

As illustrated in FIGS. 5 and 6, the damper assembly 500 may be inserted into a damper assembly mounting part 265 formed to have a predetermined insertion hole.

At this time, an area of the case body 801, disposed at the rear side of the fastening part 840, may be inserted into the damper assembly mounting part 265 and not exposed outward.

Additionally, the fastening part 840 may be coupled to the damper assembly mounting part 265, and accordingly, the damper assembly 500 may be fixed to the rear surface of the first door 210.

Accordingly, a partial area of the case body 801 disposed at the front of the fastening part 840 is only exposed to the outside of the first door 210, and most of the area of the case body 801 is not exposed to the outside of the first door 210 and does not protrude to the outside of the first door 210.

The damper assembly 500 provided as described above may help to increase the spatial availability of the hinge mounting space 260 into which the damper assembly 500 is inserted, and enhance aesthetic qualities of the refrigerator.

A reinforcement plate 900 may be disposed between the damper case 800 and the damper 600, and specifically, between the damper case 800 and the rod 620.

The reinforcement plate 900 may be disposed between the rear end portion of the case body 801 having the case groove 850 and the end portion of the rod 620. The reinforcement plate 900 disposed as described above may support the rod 620 moving toward the rear surface of the damper case 800, between the rear surface of the damper case 800 and the rod 620.

The reinforcement plate 900 may prevent a load applied by the rod 620 from concentrating on a partial area of the rear surface of the damper case 800, to protect the damper case 800, such that the damper case 800 is not damaged due to the load applied by the rod 620.

The reinforcement plate 900 may have a drawn groove 950. The drawn groove 950 may be disposed in a central portion of the reinforcement plate 900, and formed in such a way that the drawn groove 950 is depressed rearward from the front surface of the reinforcement plate 900. Because of the drawn groove 950 formed as described above, a portion of the rear surface of the reinforcement plate 900 may protrude rearward.

Preferably, the drawn groove 950 may be formed to have a shape corresponding to the shape of the cross section of the rod 620. Additionally, the cross section of a protruding portion on the rear surface of the reinforcement plate 900 may have a shape corresponding to the shape of a case groove 850.

Thus, while a portion of the rear surface of the reinforcement plate 900 facing the rear surface portion of the damper case 800 is inserted into the case groove 850, the reinforcement plate 900 may be fixed to the damper case 800.

Additionally, the rod 620 may be inserted into the drawn groove 950, and accordingly, the rod 620 may be fixed to the reinforcement plate 900. Thus, a coupling position of the rod 620 relative to the damper case 800 may be guided by the reinforcement plate 900, and the movement of the rod 620 in the up-down and left-right directions, i.e., a shake of the rod 620 may be effectively restricted by the reinforcement plate 900.

In this embodiment, the damper cover 700 may be inserted into the damper case 800, and reciprocate in the front-rear direction along the inner circumferential surface of the damper case 800.

The movement of the damper cover 700 may depend on the movement of the damper 600. That is, in the case where the damper 600 is compressed or extended, the damper cover 700 may be compressed or extended along the inner circumferential surface of the damper case 800, together with the damper 600.

In the damper assembly 500 of the embodiment, comprising the damper cover 700 described above, the damper cover 700 and the damper case 800 may protect the damper 600 from the outside. That is, the damper assembly 500 of the embodiment may prevent a side force generated by a structure making a rotation motion from being applied to the damper 600 directly, and accordingly, protect the damper 600 such that the rod 620 of the damper 600 is not bent and damaged.

Further, the damper assembly 500 of the embodiment may assist with the reciprocation of the damper 600 in the front-rear direction, based on a fastening relationship between the damper cover 700 and the damper case 800, and the holding part 720 of the rail part 710, the guide part 810 and the slit part 820.

Thus, the damper assembly 500 of the embodiment may support the damper 600 effectively to ensure a reliable movement of the damper 600 even if a side force generated by a structure making a rotation motion is applied to the damper assembly 500.

Further, in the damper assembly 500 of the embodiment, the damper 600, the damper cover 700 and the damper case 800 may be coupled based on a hook-coupling between the holding part 720 and the slit part 820, formed by an elastic force of the damper 600 itself, without an additional fastening member such as a screw.

The damper assembly 500 may reduce a man hour for assembly, ensure efficient assembly processing, and decrease costs incurred for manufacturing the damper assembly 500. [Structure of damper]

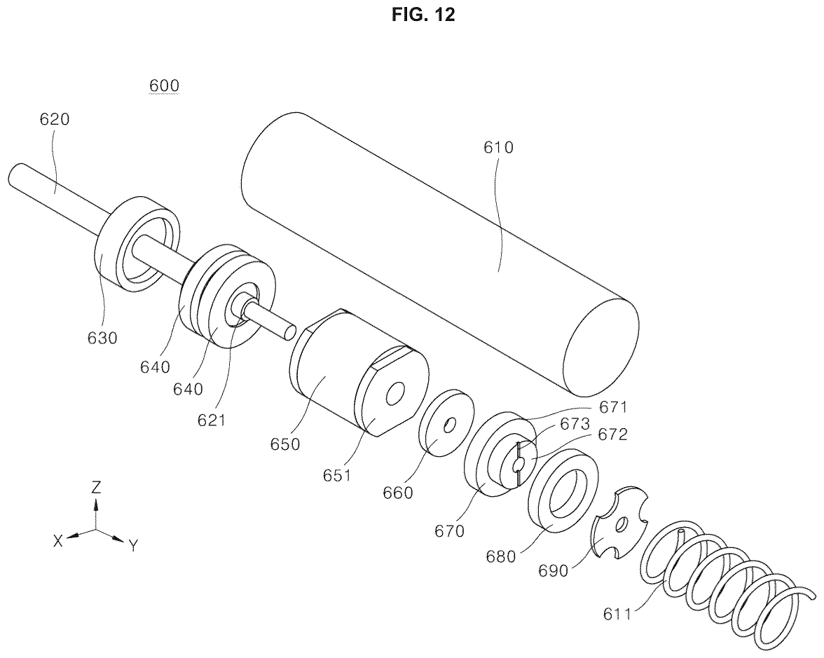

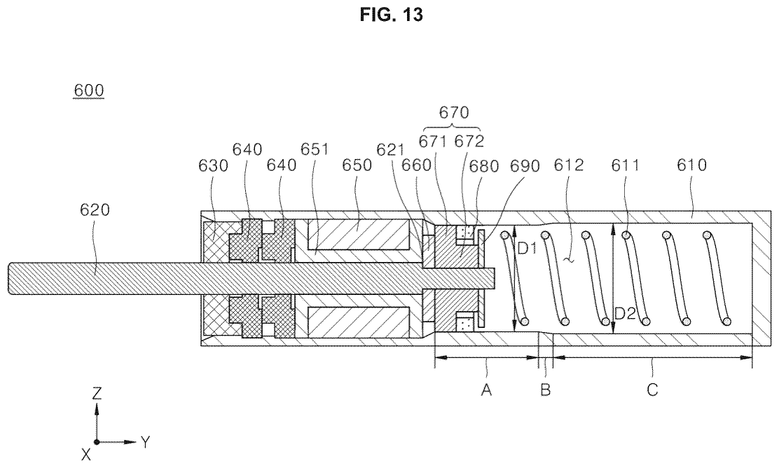

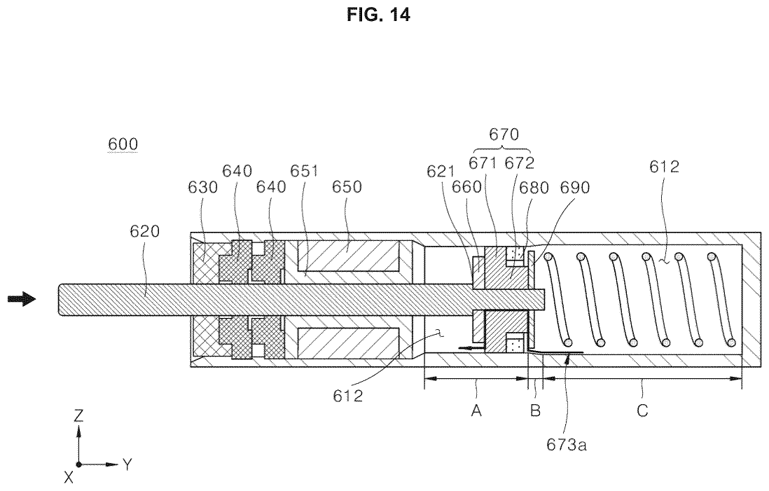

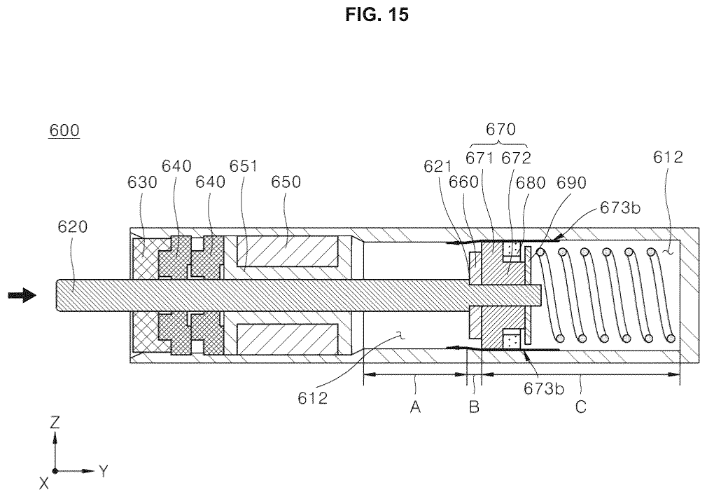

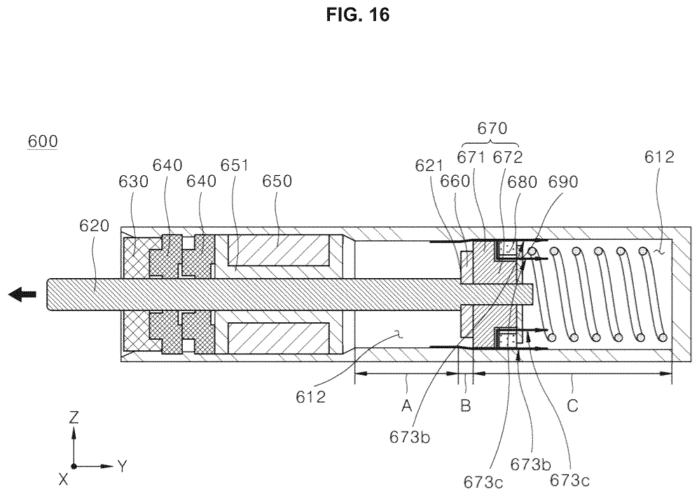

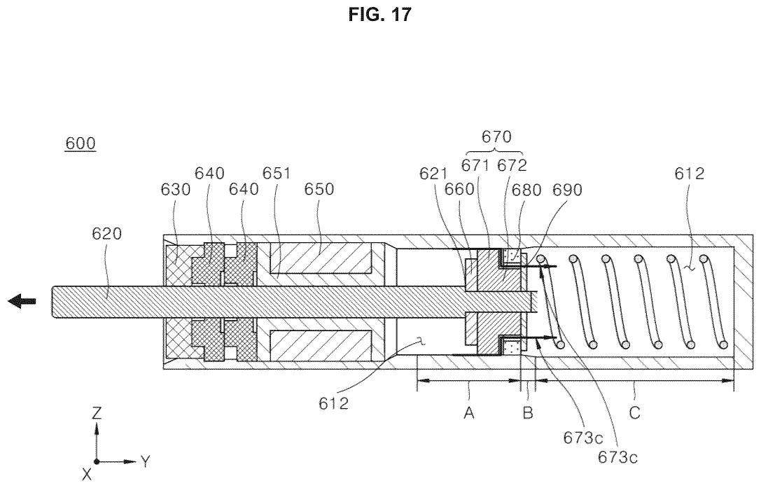

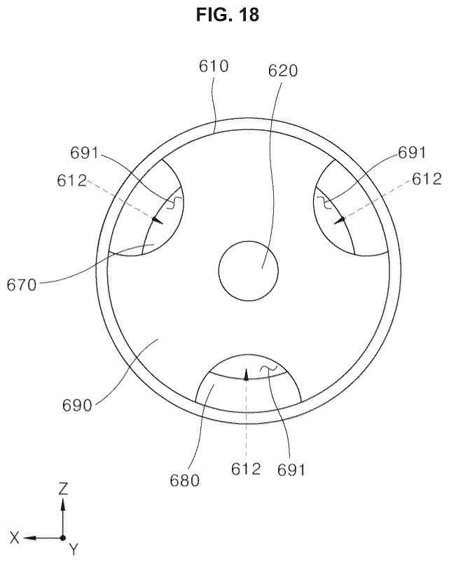

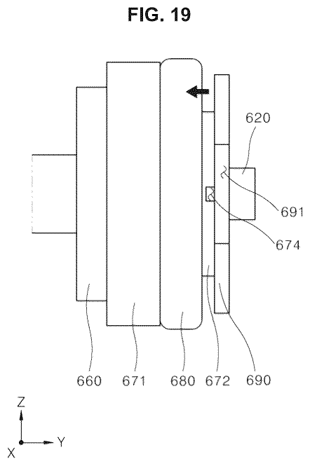

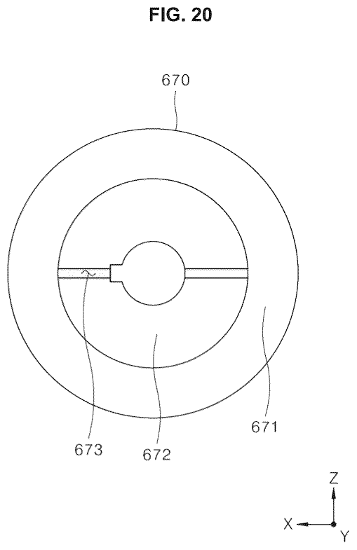

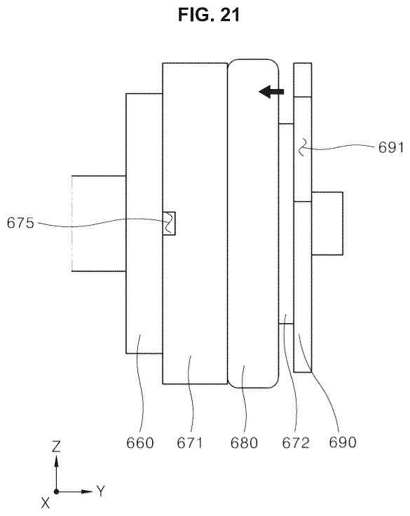

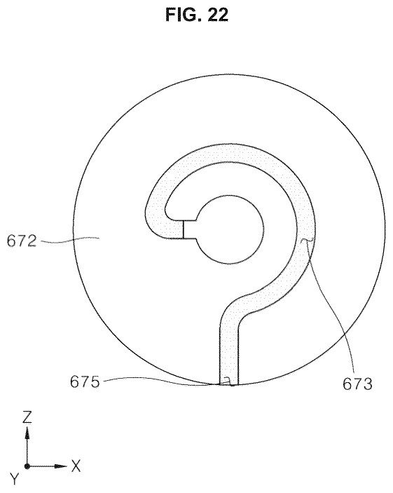

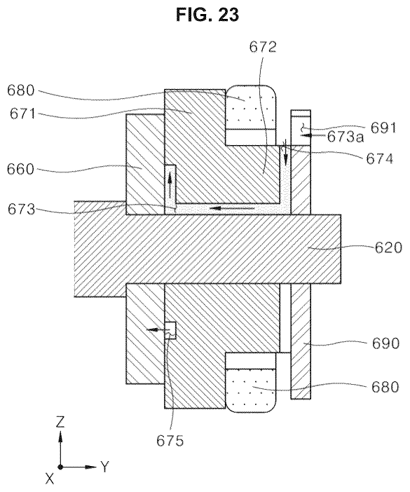

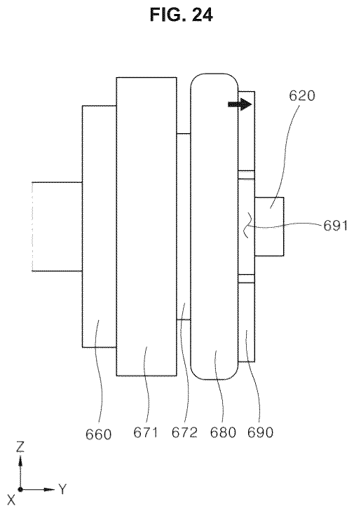

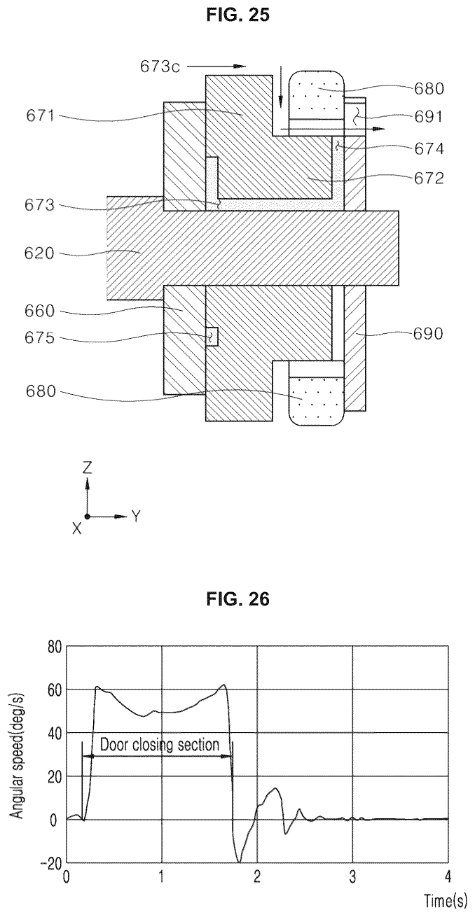

FIG. 12 is an exploded perspective view of an exploded state of a damper illustrated in FIG. 7, and FIG. 13 is a lateral cross-sectional view of the inner structure of the damper illustrated in FIG. 12. FIGS. 14 and 15 are lateral cross-sectional views of a compressed state of the damper illustrated in FIG. 13, and FIGS. 16 and 17 are lateral cross-sectional views of a return state of the damper illustrated in FIG. 15. FIG. 18 is a front cross-sectional view of a damper for showing an oil inflow path in the damper, and FIG. 19 is a view of an inlet of oil in a state where a ring contacts a first piston part. FIG. 20 is a rear view of a piston illustrated in FIG. 19, FIG. 21 is a side view of an outlet of oil in a state where a ring contacts a first piston part, and FIG. 22 is a front view of a piston illustrated in FIG. 21. FIG. 23 is a lateral cross-sectional view of a damper for showing an oil flow path part in a state where a ring contacts a first piston part, FIG. 24 is a side view of a return state of a damper, and FIG. 25 is a lateral cross-sectional view of the damper illustrated in FIG. 24.

Hereinafter, the structure of the damper 600 of the embodiment is described specifically with reference to FIGS. 12 to 25.

Referring to FIG. 12, the damper 600 may comprise a housing 610 forming the exterior of the damper 600. Additionally, the damper 600 may further comprise a guide 630, a sealer 640, a sponge 650, a sponge cover 651, a washer 660, a piston 670, a ring 680 and a bracket 690 that are accommodated in the housing 610.

In the housing 610, the guide 630, the sealer 640, the sponge 650, the sponge cover 651, the washer 660, the piston 670, the ring 680 and the bracket 690 may be coupled to the rod 620.

In this embodiment, the guide 630, the sealer 640, the sponge 650, the sponge cover 651, the washer 660, the piston 670, the ring 680 and the bracket 690 may be coupled to the rod 620 in such a way that central portions of the guide 630, the sealer 640, the sponge 650, the sponge cover 651, the washer 660, the piston 670, the ring 680 and the bracket 690 are penetrated by the rod 620, for example.

As described above, the housing 610 may have a space that accommodates the guide 630, the sealer 640, the sponge 650, the sponge cover 651, the washer 660, the piston 670, the ring 680 and the bracket 690, therein. Additionally, the housing 610 may have a cylinder space charged with oil 612, therein.

The guide 630 may be disposed closest to the open rear end portion of the housing 610 than any other component accommodated in the housing 610. The guide 620 may prevent the other components in the housing 610 from escaping out of the housing 610.

Additionally, the guide 620 may also hold the rod 620 to prevent the rod 620 from shaking in the up-down and left-right directions at a time of reciprocal-translational motion of the rod 620. As an example, the guide 630 may be made of a plastic material. Preferably, the guide 630 may be made of a polyamide nylon resin material.

The scaler 640 may be disposed at the front of the guide 630. The sealer 640 prevents the oil 612 in the housing 610 from leaking outward, and substantially seal the housing 610.

The inner circumferential surface of the sealer 640 may contact the rod 620 directly, and the outer circumferential surface of the sealer 640 may contact the inner circumferential surface of the housing 610 directly. The sealer 640 disposed between the rod 620 and the housing 610 as described above may block a gap through which the oil 612 leaks out of the housing 610.

A plurality of scalers 640 may be disposed in the housing 610. The plurality of sealers 640 may be arranged in the housing 610 in the front-rear direction. The plurality of sealers 640 may be provided to promote a leakage prevention effect further.

As an example, the sealer 640 may be made of an oil-resistant rubber. Preferably, the sealer 640 may be made of a nitrile butadiene rubber material (NBR).

The sponge 650 may be disposed at the rear of the sealer 640. That is, the sponge 650 may be disposed between the sealer 640 and the piston 670. The sponge 650 may compensate the volume of a space between the sponge 650 and the piston 670, such that the oil 612 moves in a direction opposite to the direction where the piston 670 moves forward as the damper 600 is compressed.

The sponge 650 may be made of a porous material, and the sponge 650 may be compressed by oil that flows into the space between the sponge 650 and the piston 670 as the damper 600 is compressed. The compressed sponge 650 may expand the space between the sponge 650 and the piston 670.

As an example, the sponge 650 may be made of a plastic material. Preferably, the sponge 650 may be made of a synthetic resin material.

The sponge cover 651 may be disposed between the rod 620 and the sponge 650. The sponge cover 651 may be fitted to the outer circumferential surface of the rod 620, and the sponge 650 may be installed at the sponge cover 651 in such a way that the sponge 650 surrounds the circumference of the sponge cover 651.

The sponge cover 651 may be an elastically deformable material. For example, the sponge cover 651 may be made of a plastic material. Preferably, the sponge cover 651 may be made of a polyoxymethylene (POM) material.

The sponge cover 651 may support the sponge 650 such that the sponge 650 is compressed at a time of compression of the damper 600 while the sponge returns to an original state at a time of return of the damper 600.

The washer 660 may be disposed between the sponge 650 and the piston 670. The washer 660 may promote a fastening effect between the rod 620 and the piston 670 while supporting the piston 670 at the front of the piston 670.

The front surface of the washer 660 may contact the rod 620 directly such that the front surface of the washer 660 is held and coupled to a step part 621 where the diameter of the rod 620 decreases.

The rear surface of the washer 660 may contact the front surface of the piston 670 directly, and form a flow path in which the oil 612 flows together with the piston 670. In this embodiment, the washer 660 contacts the front surface of a first piston part 671 of the piston 670, for example.

The washer 660 may be made of a metallic material. As an example, the washer 660 may be made with a steel plate cold commercial (SPCC).

The piston 670 may be disposed at the front sides of the sponge 650 and the washer 660. At least a portion of an oil flow path part may be provided at the piston 670, as illustrated in FIGS. 12, 19 and 21. The oil flow path part may form a passage required for the oil 612 to pass through the piston 670 and flow, on the piston 670, as the damper 600 is compressed.

As an example, the piston 670 may be made of a plastic material. Preferably, the piston 670 may be made of a polyamide nylon resin material.

The piston 670 may comprise a first piston part 671 and a second piston part 672 that are arranged in the front-rear direction. The second piston part 672 may protrude from the first piston part 671 forward, and the outer diameter of the second piston part 672 may be less than the outer diameter of the first piston part 671.

The bracket 690 may be disposed at the front of the piston 670. The bracket 690 may be disposed to face the second piston part 672.

The rod 620 may protrude to the front sides of the piston 670 and the bracket 690 by passing through the piston 670 and the bracket 690. The end portion of the rod 620 protruding as described above may be rivet-processed, and the piston 670 may be fixed to the rod 620 so as not to escape from the rod 620.

The bracket 690 may be disposed between the rivet-processed end portion of the rod 620 and the piston 670, such that the piston 670 is protected during rivet-processing for fixing the piston 670.

One surface of the bracket 690 may touch and contact one surface of the second piston part 672 of the piston 670, and form a flow path in which the oil 612 flows together with the piston 670.

As illustrated in FIGS. 12 and 17, a plurality of drawn parts 691 may be provided at the bracket 690. Each of the drawn parts 691 may be formed in such a way that the drawn part penetrates the bracket 690 in the front-rear direction. The plurality of drawn parts 691 may be disposed at the bracket 690 in such a way that the drawn parts 691 are spaced a predetermined distance apart from each other along the circumferential direction of the bracket 690. The oil 612 may flow through a passage formed by the drawn part 691 while passing through the bracket 690.

The bracket 690 may be made of a metallic material. As an example, the bracket 690 may be made with a steel plate cold commercial (SPCC).

A ring 680 may be disposed between the piston 670 and the bracket 690, as illustrated in FIGS. 12 and 18.

The ring 680 may be disposed between the inner circumferential surface of the housing 610 and the piston 670. The outer circumferential surface of the ring 680 may contact the inner circumferential surfaces of the housing 610, to seal between the ring 680 and the housing 610. That is, the ring 680 may block the oil from flowing through a gap between the outer circumferential surface of the ring 680 and the inner circumferential surface of the housing 610.

In this embodiment, the ring 680 and the housing 610 contact each other closely in a first inner diameter section A described hereinafter, to seal between the ring 680 and the housing 610, for example.

The ring 680 may be disposed outside the piston 670, specifically, the second piston part 672, in the diametrical direction thereof. The inner diameter of the ring 680 may be greater than the outer diameter of the second piston part 672.

The ring 680 formed as described above may be spaced a predetermined distance apart from the outer circumferential surface of the second piston part 672 and surround the second piston part 672 from the outside thereof, in the diametrical direction thereof. Accordingly, an oil return passage 681 may be formed between the inner circumferential surface of the ring 680 and the outer circumferential surface of the second piston part 672. The oil return passage 681 may provide a passage allowing the oil 612 to pass through the ring 680 and flow.

Additionally, the ring 680 may be disposed between the first piston part 671 and the bracket 690. A front-rear thickness of the ring 680 may be less than a front-rear thickness of the second piston part 672 disposed between the first piston part 671 and the bracket 690. The ring 680 formed as described above may reciprocate between the first piston part 671 and the bracket 690, in the front-rear direction, along the second piston part 672.

For example, the ring 680 may move toward the first piston part 671 as the damper 600 is compressed. Accordingly, the ring 680 may contact the first piston part 671 closely, to seal between the first piston part 671 and the ring 680, and be spaced from the bracket 690.

As sealing is done between the first piston part 671 and the ring 680 as described above, the oil 612 may not flow through the oil return passage 681, and the flow of the oil 612 may be induced such that the oil 612 only may flow through the oil flow path part provided at the piston 670.

As the damper 600 returns, the ring 680 may move toward the bracket 690. Accordingly, the ring 680 may be spaced from the first piston part 671 and open between the first piston part 671 and the ring 680. As opening is done between the first piston part 671 and the ring 680 as described above, the oil 612 may flow through the oil return passage 681.

In this embodiment, an inner diameter change section B may be in the damper 600, and the ring 680 repeats passing through the inner diameter change section B while the damper 600 is compressed and returned repeatedly.

As the ring 680 passes through the inner diameter change section B, a strong impact may be applied to the ring 680, and as the ring 680 is formed to provide a strong sealing force, frictional resistance applied to the ring 680 increases. In the case where a strong impact and frictional force are repeatedly applied to the ring 680 as described above, the sealing force of the ring 680 decreases, and the possibility of damage to the ring 680 increases.

Considering this, a ring 680 made of a material having a higher strength and a lower friction coefficient than the sealer 640 is provided in this embodiment.

Such a ring 680 may be made of a plastic material. As an example, the ring 680 may be made of fluorine resin. Preferably, the ring 680 may be made of a Teflon material.

More preferably, the ring 680 may be formed in such a way that carbon is contained in Teflon at 10% to 30% with respect to its entire weight.

Teflon exhibits higher strength and lower frictional resistance than rubber. In the case where the ring 680 is made of a Teflon material, the ring 80 may have high durability, and friction resistance applied to the ring 680 may decrease, compared to a ring made of rubber.

The sealing force of the ring 680 may be less than that of a ring made of rubber, but an effect caused by a difference between the sealing force of the ring 680 and the sealing force of the ring made of rubber may be sufficiently offset by the sealer 640 that is provided apart from the ring 680.

Unlike the ring 680, the sealer 640 is not a member that rubs against the housing 610 while moving in the housing 610 and passes through the inner diameter change section B.

That is, the sealer 640 is less affected by a strong impact and frictional resistance then the ring 680. The sealer 640 may compensate a sealing force provided by the ring 680 by providing a sufficiently high sealing force since the sealer 640 is made of rubber.

Thus, the ring 680 made of a material ensuring high durability and low frictional resistance may be disposed in an area that is affected by a strong impact and frictional resistance, and the sealer 640 made of a material providing a high sealing force may be disposed in an area that is relatively free from a strong impact and frictional resistance.

A combination of the sealer 640 and the ring 680 described above helps to provide a sufficiently effective sealing force and protect the ring 680 from damage, ensuring improvement in reliability of repetition of the damper 600.

Additionally, the ring 680 made of a Teflon material, in this embodiment, may reduce friction between the ring 680 reciprocating along the inner circumferential surface of the housing 610 and the housing 610, such that the damper 600 may operate naturally and smoothly without stopping.

The ring 680 in this embodiment may be made of a material having a higher elastic modulus than the material for the sealer 640. For example, the ring 680 in this embodiment may be made of a Teflon material having a higher elastic modulus than rubber. The shape of the ring 680 made of such a material is less deformable than that of the sealer 640.

The ring 680 may contact the housing 610 solidly in a damping section, but there is almost no change in the shape of the ring 680 in a non-damping section despite oil pressure, and the ring 680 does not contact the housing 610.

If like the sealer 640, the ring is made of a rubber material easily deformable, the shape of the ring may be easily deformable because of oil pressure, as the piston 670 compresses oil. At this time, a change in the shape of the ring may be made in such a way that the size of the ring increases in the centrifugal direction.

At this time, as the ring enters into the non-damping section, the shape of the ring changes, and accordingly, a change in the surface area of the flow path is delayed at a time of transition from the damping section to the non-damping section, and a transition to the non-damping section is delayed.

However, the ring 680 in this embodiment is made of a material that is not easily deformable, such that a transition from the damping section to the non-damping section is performed readily.

The rod 620 may be shaped into a long thin rod that extends in the front-rear direction. The rod 620 may extend rearward from the piston 670 and move together with the piston 670 in the front-rear direction.

The rod 620 may be made of a metallic material. For example, the rod 620 may be made of stainless steel.

The rod 620 may have a step part 621. The step part 621 may be formed in such a way that the inner diameter of the step part 621 is less than the inner diameter of another portion of the rod 620. The step part 621 may be disposed in an area of the rod 620 eccentric to the front thereof.

The guide 630, the sealer 640, the sponge 650 and the sponge cover 651 may be disposed at the rear of the step part 621. They may be fixed in the housing 610 without being affected by the reciprocation of the rod 620.

However, the washer 660, the piston 670, the ring 680 and the bracket 690 may be disposed at the front of the step part 621. They may move in the housing 610, together with the rod 620.

The damper 600 may further comprise an elastic member 611. The elastic member 611 may be accommodated in the housing 610, and disposed between the front end portion of the housing 610 and the bracket 690.

As an example, the elastic member 611 may be a coil spring the rear end portion of which is supported by the front end portion of the housing 610 and the front end portion of which supports the bracket 690. The elastic member 611 may provide an elastic force of returning the piston 670 having moved in a direction where the oil 612 is compressed.

The damper 600 may comprise a first inner diameter section A, a second inner diameter section C, an inner diameter change section B disposed between the first inner diameter section A and the second inner diameter section C. That is, the inside of the housing 610 may be divided into the first inner diameter section A, the inner diameter change section B and the second inner diameter section C.

The inner diameter D2 of the housing 610 in the second inner diameter section C may be greater than the inner diameter D1 of the housing 610 in the first inner diameter section A.

In the inner diameter change section B, the inner diameter of the housing 610 may continue to decrease or increase in one direction. That is, in the inner diameter change section C, an inclination surface may be formed on the inner circumferential surface of the housing 610.

Since the housing 610 has sections having a different inner diameter as described above, one damper 600 may provide various types of damping forces.

For example, a first damping force provided by the damper 600 in a first damping force section A may be greater than a second damping force provided by the damper 600 in a second damping force section C.

As an example, the first damping force section A may be a damping section in which the damper 600 provides a damping force, and the second damping force section C may be a non-damping section in which the damper 600 provides no damping force, or in which the damping section is transitioned to the non-damping section as the damper 600 is compressed.

As the damper 600 is compressed, the outer circumferential surface of the ring 680 may contact the inner circumferential surface of the housing 610 closely in the first damping force section A, such that the ring 680 blocks between the ring 680 and the housing 610.

As a gap between the ring 680 and the housing 610 is blocked by the ring 680, the oil 612 may flow only through the oil flow path part of the piston 670, and the damper 600 may provide the first damping force.

In the case where the ring 680 enters into the non-damping section, i.e., the second damping force section B, past the damping section, as the damper 600 continues to be compressed, a gap is generated between the ring 680 and the inner circumferential surface of the housing 610.

Accordingly, the oil 612 may flow through the gap between the ring 680 and the inner circumferential surface of the housing 610 as well as the oil flow path part of the piston 670.

The gap between the ring 680 and the housing 610 may form a passage that has lower flow resistance than the passage in the piston 670. Additionally, since the oil 612 flows through both of the passage formed by the gap and the oil flow path part of the piston 670, flow resistance in the second damping force section B may become much less than flow resistance in the first damping force section A.

Thus, in the second damping force section B, a damping force provided by the damper 600 becomes very low, thereby producing a non-damping effect.

The damper 600 in this embodiment may adjust a damping force in stages, in the case where the damper 600 is compressed, based on a difference in the inner diameter of the housing 610 through a step.

The damper 600 may readily provide a damping force in stages without causing large costs based on a simple process in which the inner shape of the housing 610 changes slightly, rather than a complex and expensive process in which the viscosity of oil 612 varies in each section or in which the diameter of the oil flow path part of a piston 670 varies in each section.

### [Operation Structure of Damper]

Hereinafter, the operation structure of the damper 600 is described specifically.

Referring to FIGS. 19 and 23, the second piston part 672 may have an inlet 674. The inlet 674 may be provided in a groove shape that is concavely formed on the front surface the second piston part 672.

The inlet 672 formed as described above may extend toward the open center of the piston 670, and extend rearward along the inner circumferential surface of the piston 670 at the open center of the piston 670. The inlet 672 may extend to a position where the inlet 672 connects to the rear surface of the piston 670.

The first piston part 671 may have an outlet 675. The outlet 675 may be provided in a groove shape that is concavely formed on the rear surface of the first piston part 671.

The oil 612 having flown into the inlet 674 and then having passed through the piston 670 through the open center of the piston 670 may be discharged out of the piston 670 through the outlet 675.

Referring to FIGS. 14, 15 and 23, the oil flow path part in this embodiment may comprise a first flow path 673a. The first flow path 673a may provide a path comprising the drawn part 691 formed at the bracket 690, the space formed between the drawn part 691 and the ring 680, the inlet 674 and the outlet 675.

The first flow path 673a may provide a path comprising the drawn part 691 formed at the bracket 690, the space formed between the drawn part 691 and the ring 680, the inlet 674 and the outlet 675.

For example, in the first flow path 673a, the oil 612 may pass through the bracket 690 through the drawn part 691, flow into the space formed between the drawn part 691 and the ring 680 and then be drawn between the second piston part 672 and the bracket 690 through the inlet 674.

As described above, the oil 612 drawn between the second piston part 672 and the bracket 690 may flow into the outlet 675 through a passage formed between the rod 620 penetrating the center of the piston 670 and the piston 670.

The oil 612 having flown into the outlet 675 may flow through a passage formed between the first piston part 671 and the washer 660 and then be discharged to the rear side of the piston 670.

As the entire length of the first flow path 673a increases, a deviation from the damping force of the damper 600 may decrease. To minimize the deviation from the damping force of the damper 600, the first flow path 673a is preferably designed to make the longest detour.

To this end, in this embodiment, the outlet 675 may be shaped to comprise a section in which the outlet 675 extends along the circumferential direction of the piston 670, as illustrated in FIGS. 21 and 22.

As an example, the outlet 675 may be divided into three sections. A first section of the outlet 675 is a section connecting to the open center of the piston 670, i.e., a section connecting to the inlet 674. The first section of the outlet 675 may be formed in such a way that the first section extends at the open center of the piston 670 in the centrifugal direction.

A third section of the outlet 675 is a section connecting to the outside of the first piston part 671 in the diametrical direction thereof, i.e., a section in which the outlet 675 is exposed outward in the diametrical direction of the piston 670. The third section of the outlet 675 may be formed in such a way that the third section extends from the outer circumferential surface of the first piston part 671 in the centripetal direction thereof.

A second section of the outlet 675 is a section connecting between the first section and the third section of the outlet 675. The second section of the outlet 675 may be formed in such a way that the second section extends along the circumferential direction of the piston 670. That is, the second section of the outlet 675 may extend in such a way that the second section detours in a round manner, around the open center of the piston 670, along the circumferential direction of the piston 670, rather than connecting between the first section and the third section of the outlet 675 linearly.

Thanks to the second section of the outlet 675 formed described above, the entire length of the outlet 675 may extend effectively. Accordingly, the entire length of the first flow path 673a increases, and a deviation from the damping force of the damper 600 may decease effectively.

Referring to FIGS. 14 and 23, the rod 620 and the piston 670 may move forward as the damper 600 is compressed. As the rod 620 and the piston 670 move forward, the ring 680 may contact the first piston part 671 closely.

Because of a frictional force acting between the inner circumferential surface of the housing 610 and the ring 680, the position of the ring 680 may be maintained until the ring 680 contacts the first piston part 671. In the case where the piston 670 continues to move forward in the state where the ring 680 contacts the first piston part 671, the ring 680 may move forward together with the piston 670.

While the piston 670 compresses the oil 612 and the ring 680 moves in the first inner diameter section A, the oil 612 in a space disposed further forward than the piston 670, i.e., a space between the anterior portion of the housing 610 and the piston 670 (hereinafter, “anterior space”), may pass through the piston 670 through the first flow path 673a and flow to a space between the piston 670 and the sponge 650 (hereinafter, “posterior space”).

The oil flow path part in this embodiment, as illustrated in FIGS. 15 and 16, may further comprise a second flow path 673b. The second flow path 673b may provide a path comprising a path between the outer circumferential surface of the first piston part 671 and the inner circumferential surface of the housing 620, and a path between the outer circumferential surface of the ring 680 and the inner circumferential surface of the housing 610.

For example, in the second flow path 673b, the oil 612 may flow forward or rearward by consecutively passing through a path between the outer circumferential surface of the first piston part 671 and the inner circumferential surface of the housing 620 and between the outer circumferential surface of the ring 680 and the inner circumferential surface of the housing 610.

As an example, as illustrated in FIG. 15, while the piston 670 compresses the oil 612 and the ring 680 moves in the second inner diameter section C, the oil 612 in the anterior space may flow rearward while passing through the piston 670 though the second flow path 673b.

Since the inner diameter of the housing 610 in the second inner diameter section C is greater than in the first inner diameter section A, a gap is created between the outer circumferential surface of the ring 680 and the inner circumferential surface of the housing 610. The gap between the ring 680 and the housing 610 in the second flow path 673b may form a passage having lower flow resistance than in the first flow path part 673a.

That is, the second flow path 673b may form a passage having lower flow resistance than the first flow path 673a, such that the oil 612 may flow in the second flow path 673b rather than the first flow path 673a.

Additionally, the oil flow path part in this embodiment may further comprise a third flow path 673c as illustrated in FIGS. 16, 17 and 25. The third flow path 673c may provide a path comprising a path between the outer circumferential surface of the first piston part 671 and the inner circumferential surface of the housing 620, the oil return passage 681 and the drawn part 691.

For example, in the third flow path 673c, the oil 612 may flow forward by consecutively passing through a path between the outer circumferential surface of the first piston part 671 and the inner circumferential surface of the housing 620, the oil return passage 681 and the drawn part 691.

As the piston 670 returns, that is, the piston 670 moves forward, the bracket 690 may move forward together with the piston 670. Because of a frictional force acting between the inner circumferential surface of the housing 610 and the ring 680, the position of the ring 680 may be maintained until the ring 680 contacts the bracket 690.

After the ring 680 contacts the bracket 690, the ring 680 may move forward together with the piston 670 and the bracket 690. In this process, the ring 680 may be spaced from the first piston part 671 and open between the first piston part 671 and the ring 680. As opening is done between the first piston part 671 and the ring 680, the oil 612 may flow through the oil return passage 681.

As illustrated in FIGS. 16, 24 and 25, while the piston 670 returns and the ring 680 moves in the second inner diameter section C, the oil 612 in the posterior space may flow forward while passing through the piston 670 through the third flow path 673c.

Referring to FIGS. 17, 24 and 25, while the piston 670 returns and the ring 680 passes through the first inner diameter section A, the ring 680 and the housing 610 contact each other closely, and the gap between the outer circumferential surface of the ring 680 and the inner circumferential surface of the housing 610 disappears.

Thus, the second flow path 673b is blocked, and the oil 612 in the posterior space may pass through the piston 670 through the third flow path 673c and flow to the anterior space.

### [Operation of Damper Assembly]

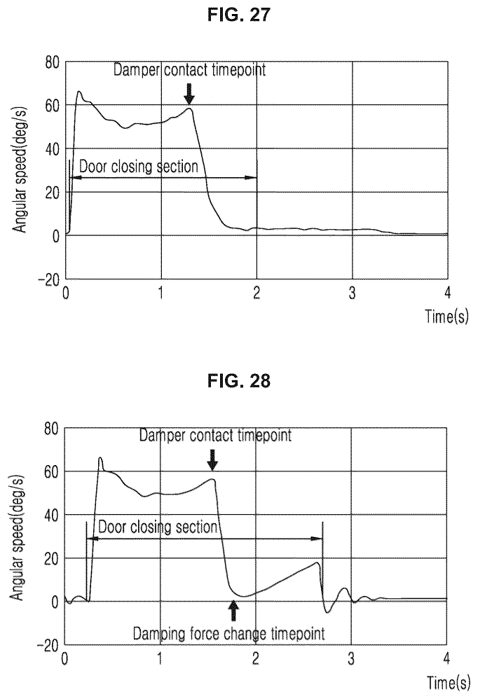

FIG. 26 is a graph of a trend of changes in the closing speeds of a door without a damper, FIG. 27 is a graph of a trend of changes in the closing speeds of a door with a damper which provides a damping force constantly, and FIG. 28 is a graph of a trend of changes in the closing speeds of a door with a damper comprising a section where a damping force changes.

In the case where the damper is not mounted on the door as illustrated in FIG. 26, the angular speed of the door almost never decreases in a section where the door rotates in a closing direction to be closed (hereinafter, “door closing section”).

Thus, as the door is closed, a collision between the door and the cabinet results in a strong impact, and as a result, the door bounces seriously, as shown on the graph of FIG. 26.

As another example, in the case where a one-stage damper providing a damping force of constant magnitude is applied to the refrigerator as illustrated in FIG. 27, the one-stage damper may continue to provide a damping force of constant magnitude to the door.

Accordingly, the angular speed of the door may continue to decrease until the door is closed, after a damper contact timepoint in the door closing section.

As a result, the magnitude of an impact that is generated as the door is closed may decrease significantly, and the door almost never bounces, as shown on the graph of FIG. 27.

However, in the case where the one-stage damper operating as described above and a pillar are applied together to the refrigerator, the door may not be closed properly.

That is, in the case where the one-stage damper that continues to provide a damping force of constant magnitude is applied to the refrigerator, if resistance caused by the pillar is added to a damping force of the damper in the door closing section, the door may not frequently be closed completely.

In the case where a two-stage damper comprising a section where a damping force changes is mounted on the refrigerator as illustrated in FIG. 28, the two-stage damper may provide a first damping force to the door after a timepoint when the two-stage damper contacts the hinge assembly (P1; hereinafter, “damper contact timepoint”), and then provide a second damping force to the door after a timepoint when the damping force of the damper changes (P2; hereinafter, “damping force change timepoint”).

Accordingly, the angular speed of the door decreases after the damper contact timepoint P1 in the door closing section, and then increases after the damping force change timepoint P2, as shown on the graph of FIG. 28.

A decrease in the angular speed of the door in the door closing section results from a damping force caused by the operation of the two-stage damper in the first damping force section (A; see FIG. 14), i.e., the damping section. Additionally, an increase in the angular speed of the door in the door closing section results from the operation of the two-stage damper in the second damping force section (B; see FIG. 15), i.e., the non-damping section.

As the pillar is unfolded in the section where the angular speed of the door increases again, the door is closed completely even if resistance is applied because of the unfolding of the pillar, and in this process, the door bounces slightly.

In the case where the two-stage damper is applied to the door as described above, at a moment when the door is closed completely, the door bounces further than in the case where the one-staged damper is applied to the door, but there is no big difference in the bounces, causing no inconvenience to the user.

That is, in the case where the two-stage damper is applied to the door as illustrated in this embodiment, a sufficient damping force required to open and close the door smoothly may be provided, and failure in closing of the door may be effectively solved without causing significant inconvenience to the user.

### [Interaction Between Damper Assembly and Pillar and Result Effect]

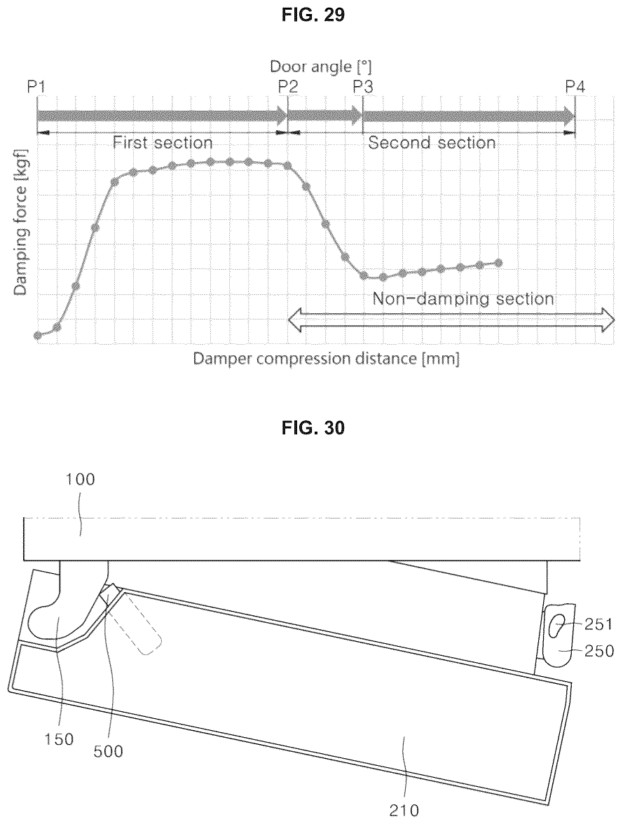

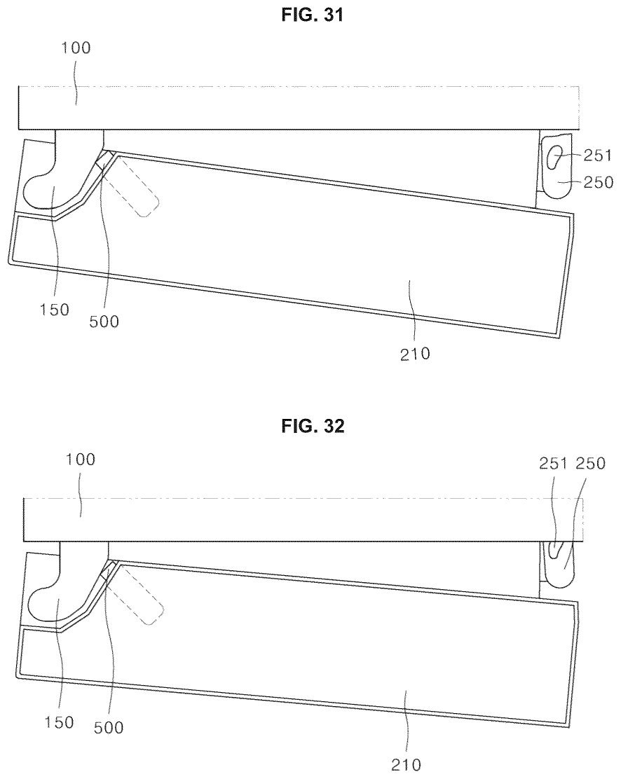

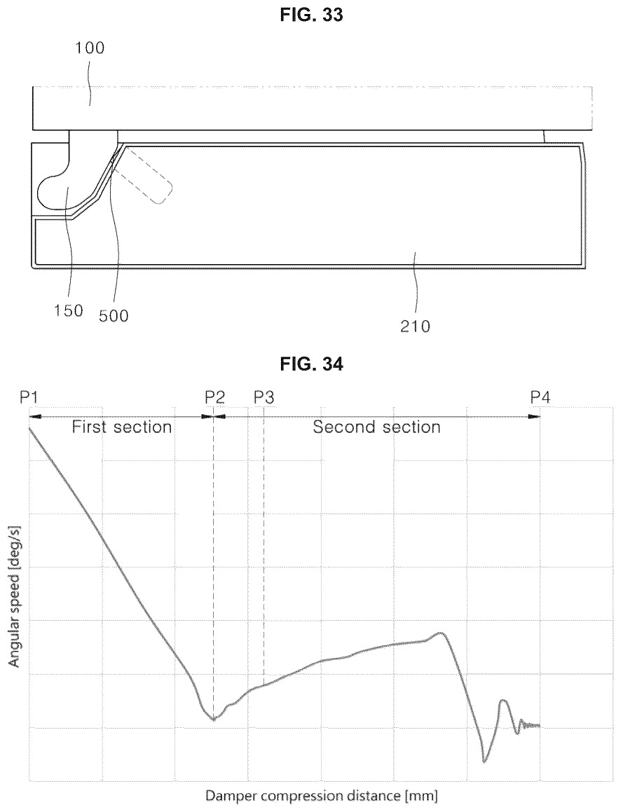

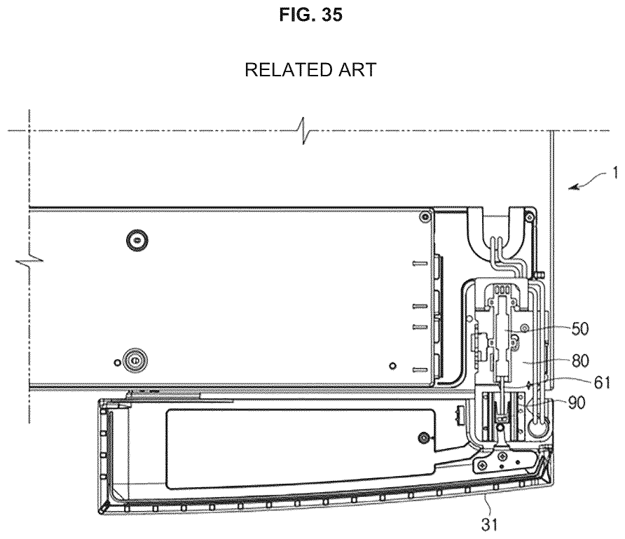

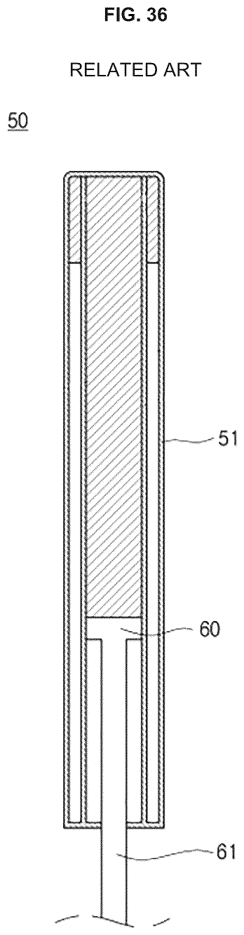

FIG. 29 is a graph of a change in the damper compression distances, and a change in the damping forces based on a change in the door angles, FIG. 30 is a planar cross-sectional view of a rotation state of a door at a damper contact timepoint. FIG. 31 is a planar cross-sectional view of a rotation state of a door at a timepoint when a second set angle is reached, and FIG. 32 is a planar cross-sectional view of a rotation state of a door at a timepoint when a third set angle is reached. FIG. 33 is a planar cross-sectional view of a door closed, and FIG. 34 is a graph of a change in the angular speeds based on each damper compression distance.

Hereinafter, the operation and effect of the damper assembly of one embodiment are described with reference to FIGS. 1 to 34.

As illustrated in FIGS. 1 to 7, a two-stage damper-type damper 600 providing two types of damping forces is applied to the damper assembly 500 in this embodiment. The damper assembly 500 may provide a first damping force or a second damping force, depending on a degree to which the damper 600 is compressed.

That is, the damper assembly 500 in this embodiment may provide a first damping force in an initial stage of compression of the damper 600, and then as the damper 600 continues to be compressed, provide a second damping force of less magnitude than the first damping force.

The door 210, 220, 230, as described above, may be rotatably installed at the cabinet 100 and open and close a storage compartment. The door 210, 220, 230 may be rotatably installed in the closing direction and an opening direction.

Specifically, the door 210, 220, 230 may close the storage compartment by rotating in the closing direction, and open the storage compartment by rotating in the opening direction.

In this embodiment, a rearward rotation of the door 210, 220, 230 is a rotation in the closing direction of the door 210, 220, 230, and a forward rotation of the door 210, 220, 230 is a rotation in the opening direction of the door 210, 220, 230, for example.

The damper assembly 500 in this embodiment may provide a damping force that is resistant against the rotation of the door 210, 220, 230 in the closing direction. That is, the damper assembly 500 may provide a damping force that is resistant against the rearward rotation of the door 210, 220, 230, that is, a rotation of the door 210, 220, 230 for closing the storage compartment.

In this embodiment, a damper assembly 500 providing a damping force applied to the upper door 210, 220, is provided as an example. Additionally, in this embodiment, the damper assembly 500 is installed respectively at the upper door 210, 220, for example.

Additionally, a pillar 250 is installed at the upper door 210, 220, but in this embodiment, installed at the first door 210, for example.

Hereinafter, the operation of the damper assembly 500 is described in the case where the damper assembly 500 and the pillar 250 are installed at the first door 210.

As described above, a damper 600 provided in a two-stage damper shape capable of providing a first damping force and a second damping force may be applied to the damper assembly 500 in this embodiment. The damping force provided by the damper 600 provided in a two-stage damper shape may change from a first damping force to a second damping force while the first door 210 rotates in the closing direction.

The damper assembly 500 in this embodiment may operate based on at least any one of a first damping operation of providing the first damping force and a second damping operation of providing the second damping force.

Referring to FIGS. 29 to 33, as the damper assembly 500 operates based on the first damping operation, the damper 600 may be compressed in the first damping force section A, and accordingly, the damper assembly 500 may provide the first damping force (see FIG. 30).

Further, as the damper assembly 500 operates based on the second damping operation, the camper 600 may be compressed in the first damping force section A, and accordingly, the damper assembly 500 may provide the second damping force (sees FIG. 31).

While the first door 210 rotates in the closing direction, the first damping operation and the second damping operation may be performed consecutively at the damper assembly 500.

That is, the damper assembly 500 in this embodiment may provide the first damping force to the first door 210, based on the first damping operation, and then provide the second damping force to the second door 210, based on the second damping operation, while the first door 210 rotates in the closing direction.

As the first door 210 rotates in the closing direction, the damper assembly 500 may start to provide a damping force, at a timepoint when an angle formed by the front surface of the cabinet 100 and the first door 210 becomes a first set angle α or less (see FIG. 30).

The damper assembly 500 may generate a damping force while contacting at least any one of the front surface of the cabinet 100 and the hinge assembly 150. In this embodiment, the damper assembly 500 generates a damping force while contacting the hinge assembly 150, for example.

Accordingly, the damper assembly 500 may generate a damping force while the damper assembly 500 is pressed by the hinge assembly 150. As the first door 210 rotates in the closing direction, the damper assembly 500 may move to approach toward the hinge assembly 150, while moving together with the first door 210.

The damper assembly 500 having moved to approach toward the hinge assembly 150, based on the rotation of the first door 210 in the closing direction, may generate a damping force while being pressed by the hinge assembly 150.

In this embodiment, as the first door 210 rotates in the closing direction, the damper assembly 500 may contact the hinge assembly 150 from the timepoint when the angle formed by the front surface of the cabinet 100 and the first door 210 becomes the first set angle α or less.

In this embodiment, the first set angle α may be set to an angle within a range of acute angles. As an example, the first set angle α may be set to an angle within a range of 10 to 20°. Preferably, the first set angle α may be set to an angle within a range of 12 to 17°.

The timepoint when the damper assembly 500 contacts the hinge assembly 150 as described above, i.e., the damper contact timepoint P1, the damper assembly 500 may operate based on the first damping operation and provide the first damping force.

In the case where the first door 210 continues to rotate in the closing direction in the above-described state, and a timepoint when the angle formed by the front surface of the cabinet 100 and the first door 210 becomes a second set angle β or less (P2; hereinafter, “second set angle reaching timepoint) has come, the operation of the damper assembly 500 may transition from the first damping operation to the second damping operation (see FIG. 31).

In this embodiment, the second set angle β may be set to an angle within a range of angles greater than 0° and less than the first set angle α. As an example, the second set angle may be set to an angle in a range of 5 to 9°. Preferably, the second set angle β may be set to an angle within a range of 6 to 8°.

As the operation of the damper assembly 500 transitions from the first damping operation to the second damping operation as described above, a damping force provided by the damper assembly 500 may change from the first damping force to the second damping force.

As described above, the first door 210 may be provided with a pillar 250. The pillar 250 may start to be unfolded right before the first door 210 rotating in the closing direction is closed, and be completely unfolded in the state where the first door 210 is closed and block a gap between the first door 210 and the second door 220.

Specifically, in the case where an angle formed by the first door 210 rotating in the closing direction and the front surface of the cabinet 100 is within a range of angles from greater than 0° and the second set angle β or less, the pillar 250 may start to be unfolded while contacting the cabinet 100, specifically, the pillar rotation member 101.

For example, the pillar 250 may start to be unfolded at a timepoint when the angle formed by the front surface of the cabinet 100 and the first door 210 becomes a third set angle γ or less (P3; hereinafter, “third set angle reaching timepoint”). The third set angle γ may be set to an angle greater than 0° and the second set angle β or less (see FIG. 32).

The third set angle γ may set to an angle closer to the second set angle β than 0°. Additionally, the second set angle β may be set to an angle closer to the third set angle γ than the first set angle α.

That is, the first set angle, the second set angle and the third set angle may satisfy the following relationships.

$$β - γ << γ ,$$

$$β - γ << \text{α-β} ,$$

Accordingly, a different between the second set angle β and the third set angle γ may be much less than a difference between the angle 0°, formed by the first door 210 with the storage compartment closed and the front surface of the cabinet 100, and the third set angle γ. Further, a different between the second set angle β and the third set angle γ may be much less than a difference between the first set angle α and the second set angle β.

As an example, in the case where the second set angle is 8° while the first set angle α is 15°, the third set angle may be set to 6°.

That is, the pillar 250 may start to be unfolded, at a timepoint very close to the timepoint when the operation of the damper assembly 500 transitions from the first damping operation to the second damping operation, that is, right after the operation of the damper assembly 500 transitions from the first damping operation to the second damping operation.

As another example, the pillar 250 may start to be unfolded right before the operation of the damper assembly 500 transitions from the first damping operation to the second damping operation. In this embodiment, the pillar 250 starts to be unfolded right after the operation of the damper assembly 500 transitions from the first damping operation to the second damping operation, for example.

The pillar 250 described above may provide a resistant force to the first door 210 while the pillar 250 is unfolded contacting the pillar rotation member 101. The resistant force provided by the pillar 250 may be provided in such a way that the resistant force is similar to the damping force provided by the damper assembly 500.

That is, the damper assembly 500 may provide a force resistance against a rotation of the first door 210 in the closing direction, and the pillar 250 may also provide a force resistance against a rotation of the first door 210 in the closing direction. Considering this, the resistant force provided by the pillar 250 is referred to as a third damping force.

As described above, the first door 210 may rotate in the closing direction to close the storage compartment. As the angle formed by the first door 210 rotating in the closing direction and the front surface of the cabinet 100 becomes the first set angle α, the damper assembly 500 may contact the hinge assembly 150.

From the damper contact timepoint P1, the damper assembly 500 may provide the first damping force while operating based on the first damping operation. That is, the damper assembly 500 may operate based on the first damping operation in the firsts section that is a section between the damper contact timepoint P1 and the second set angle reaching timepoint P2.

That is to say, in the first section, which is a section between a point at which the operation of the damper assembly 500 starts and a point at which the angle between the front surface of the cabinet 100 and the first door 210 becomes the second set angle, the damper assembly 500 may operate based on the first damping operation.

Accordingly, in the first section, the first damping force may be applied to the first door 210, and provide a force of resisting against the rotation of the first door 10 in the closing direction.

In the first section that is a section between the damper contact timepoint P1 and the second set angle reaching timepoint P2, the first damping force described above may allow the first door 210 to rotate slower than usual and to start to be closed smoothly.

At a timepoint when the first door 210 continues to rotate in the closing direction and the angle formed by the front surface of the cabinet 100 and the first door 210 becomes the second set angle β or less, i.e., at the second set angle reaching timepoint P2, the operation of the damper assembly 500 may transition from the first damping operation to the second damping operation.

In this embodiment, a section between a point at which the first door 210 closes the storage compartment and the point at which the angle between the front surface of the cabinet 100 and the first door 210 becomes the second set angle may be defined as a second section. That is, in this embodiment, a section between the second set angle reaching timepoint P2 and a timepoint when the first door 210 is closed completely P4 may be defined as the second section.

In the second section, the damper assembly 500 may provide the second damping force while operating based on the second damping operation, and accordingly, the second damping force of less magnitude than the first damping force may be applied to the first door 210.

As an example, a non-damping effect may be produced while the operation of the damper assembly 500 transitions from the first damping operation to the second damping operation from the second set angle reaching timepoint P2. That is, an environment is created where in the second section, the non-damping effect may be produced and accordingly, the rotation speed of the first door 210 may increase gradually.

Further, in this embodiment, the pillar 250 may start to be unfolded at a timing close to the second set angle reaching timepoint P2.

At a timepoint when the angle formed by the front surface of the cabinet 100 and the first door 210 becomes the third set angle γ or less, i.e., at the third set angle reaching timepoint P3, the pillar 250 may start to be unfolded while contacting the pillar rotation member 101.

As the pillar 250 starts to be unfolded, the pillar 250 may provide the third damping force that resists against the rotation of the first door 210 in the closing direction.

That is, while the pillar 250 is unfolded, an environment is created where the rotation speed of the first door 210 is decreased gradually by the third damping force provided by the pillar 250.

In this embodiment, the pillar 250 is unfolded in the second section, for example. That is, the pillar 250 may start to be unfolded while contacting the cabinet 100 or the pillar rotation member 101, in the second section.

In the case where the operation of the damper assembly 500 is maintained in the first damping operation while the pillar 250 is unfolded as described above, the first damping force and the third damping force act together to the first door 210, at the timing.

As the first damping force and the third damping force act together to the first door 210 as described above, in the case where a total force of the first damping force and the third damping force is greater than a force of rotating the first door 210 in the closing direction, the first door 210 may not be closed properly.

At this time, in the case where the first damping force decreases, the damper assembly 500 may produce a mere damping effect, and the first door 210 may not be closed smoothly.

Additionally, since the third damping force is a resistant force that must be generated while the pillar 250 is unfolded, it is not easy to reduce the third damping force.

That is, in a situation where the total force of the first damping force and the third damping force needs to be the force of rotating the first door 210 in the closing direction or less, it is difficult to reduce any of the first damping force and the third damping force easily.

Considering this, in this embodiment, the operation of the damper assembly 500 transitions from the first damping operation to the second damping operation at a timing close to the third set angle reaching timepoint P3 when the pillar 250 starts to be unfolded.

That is, in this embodiment, the damper assembly 500 may operate to apply the first damping force to the first door 210 before the pillar 250 starts to be unfolded, and from a timepoint close to the time point where the pillar 250 is unfolded, the operation of the damper assembly 500 may transition to apply the second damping force to the first door 210 rather than the first damping force.

Accordingly, before the pillar 250 starts to be unfolded, the rotation speed of the first door 210 is reduced based on the application of the first damping force, and the first door 210 may be closed smoothly. Further, while the pillar 250 is unfolded, i.e., the third damping force is applied to the first door 210 by the pillar 260, the second damping force may act to the first door 210 together with the third damping force.

In this embodiment, the magnitude of the first damping force F1, the magnitude of the second damping force F2 and the magnitude of the third damping force F3 may satisfy the following relationships.

$$F 2 + F 3 \leq F 1 ,$$

$$F 2 < F 1 ,$$

$$F 2 < F 3 ,$$

$$F 3 \leq F 1 ,$$

Accordingly, the magnitude of the second damping force F2 may be set to be less than the magnitude of the first damping force F1. Additionally, the magnitude of the second damping force F2 may be set to be less than the magnitude of the third damping force F3, and the magnitude of the third damping force F3 may be set to be the magnitude of the first damping force F1 or less. Further, a total of the magnitude of the second damping force F2 and the magnitude of the third damping force F3 may be set to be the magnitude of the first damping force F1 or less.

Since the relationships among the magnitude of the first damping force F1, the magnitude of the second damping force F2 and the magnitude of the third damping force F3 are set as described above, a total of resistant forces applied to the first door 210 while the pillar 250 is unfolded may be maintained at a resistant force applied to the first door 210 while the pillar is not unfolded or less.

That is, a resistant force acting to the first door 210 may not be greater than the magnitude of the first damping force F1 even during the unfolding of the pillar 250, and may be maintained at the magnitude of the first damping force F1 or less, regardless of the unfolding of the pillar 250.

Thus, the rotation speed of the first door 210 during the unfolding of the pillar 250 is unfolded may be maintained at a minimum rotation speed of the first door 210 or greater during the operation of the damper assembly 500 based on the first damping operation.

Referring to FIGS. 28 to 32, the rotation speed of the first door 210 may be the least at a timepoint when the operation of the damper assembly 500 transitions from the first damping operation to the second damping operation, since the rotation speed of the first door 210 continues to decrease while the first damping force acts to the first door 210.

In the case where the first door 210 rotates normally in the closing direction without stopping when the rotation speed of the first door 210 is the minimum rotation speed as described above, the first door 210 may continue to rotate without stopping while the rotation speed of the first door 210 is maintained at the minimum rotation speed or greater.

In the case where the rotation speed of the first door 210 is maintained at the minimum rotation speed or greater while the pillar 210 is unfolded as illustrated in this embodiment, the first door 210 may continue to rotate without stopping even during the unfolding of the pillar 250.

In this embodiment, even during the unfolding of the pillar 250, a resistant force acting to the first door 210 is not greater than the magnitude of the first damping force F1, and accordingly, the rotation speed of the first door 210 may be maintained at the minimum rotation speed or greater during the unfolding of the pillar 250.

Thus, the pillar 250 may be unfolded smoothly, and the rotation of the first door 210 in the closing direction may be performed smoothly without stopping until the first door 210 is closed completely.

Further, before the unfolding of the pillar 250, the rotation speed of the first door 210 may be reduced by the first damping force provided by the damper assembly 500 operating based on the first damping operation, and then reduced by the third damping force provided based on the unfolding of the pillar 250.

Accordingly, the damper assembly 500 and the pillar 250 in this embodiment may provide a sufficient damping force needed to close the first door 210 smoothly, and while the first door 210 is closed, effectively reduce an impact that may be applied to the first door 210 or the pillar 250 and its surrounding structures, thereby preventing damage to the first door 210 or the pillar 250 and its surrounding structures.

That is, the damper assembly 500 and the pillar 250 in this embodiment, may provide a sufficient damping force effectively to allow the first door 210 to be opened and closed smoothly and prevent damage to the structures in relation to the opening and closing of the first door 210 and the unfolding of the pillar 250, while enabling the first door 210 to be closed and the pillar 250 to be unfolded smoothly without stopping.

Further, the third set angle reaching timepoint P3 may be set to a timing very close to the second set angle reaching timepoint P2, and set to a timepoint right before the second set angle reaching timepoint P2 or right after the second set angle reaching timepoint P2 or set to a timepoint simultaneous with the second set angle reaching timepoint P2.

That is to say, the second set angle reaching timepoint P2 may be set within a set time range comprising the third set angle reaching timepoint P3.

In this embodiment, the third set angle reaching timepoint P3 is set to a timepoint right after the second set angle reaching timepoint P2, for example.

Accordingly, right after the operation of the damper assembly 500 transitions from the first damping operation to the second damping operation, the pillar 250 may start to be unfolded.

That is to say, the operation of the damper assembly 500 may transition from the first damping operation to the second damping operation, before the timepoint when the pillar 250 contacts the cabinet 100 or the pillar rotation member 101 or the pillar 250 is unfolded.

That is, the damper assembly 500 may operate based on the first damping operation by contacting the door 210 rotating in the closing direction, and then operate based on the second damping operation before the timepoint when the pillar 250 contacts the cabinet 100 or the pillar rotation member 101 or the pillar 250 is unfolded.

Thus, the unfolding of the pillar 250 may start in the state where a damping force acting to the first door 210 has already decreased from the first damping force to the second damping force. Further, the unfolding of the pillar 250 may start in the state where the rotation speed of the first door 210 increases to some degree, rather than the state where the rotation speed of the first door 210 is the least.

As described above, the rotation speed of the first door 210 may be the least at the timepoint when the operation of the damper assembly 500 transitions from the first damping operation to the second damping operation.

Further, after the timepoint when the operation of the damper assembly 500 transitions from the first damping operation to the second damping operation, the damping force acting to the first door 210 decreases from the first damping force to the second damping force, and the rotation speed of the first door 210 starts to increase.

In this embodiment, the pillar 250 may start to be unfolded at the timing when the rotation speed of the first door 210 starts to increase as described above.

Thus, a total of the magnitude of the second damping force and the magnitude of the third damping force is maintained at the magnitude of the first damping force or less, and the pillar 250 starts to be unfolded in the state where the rotation speed of the first door 210 increases, to enable the pillar 250 to be unfolded smoothly and enable the first door 210 to rotate smoothly.

Ordinarily, the third damping force may act to the first door 210 as the greatest force, at an initial timing of the unfolding of the pillar 250. At the initial timing of the unfolding of the pillar 250, the pillar 250 contacts the cabinet 100 or the pillar rotation member 101 initially, and the direction of the pillar 250 changes with the greatest width.

That is, the magnitude of the third damping force is ordinarily the greatest at the initial timing of the unfolding of the pillar 250, and then decreases gradually until the magnitude of the third damping force becomes predetermined magnitude.

Considering this, in this embodiment, an operation transition timing of the damper assembly 500 and an unfolding timing of the pillar 250 may be set, such that the pillar 250 may start to be unfolded after the operation of the damper assembly 500 transitions from the first damping operation to the second damping operation, and at the timing when the rotation speed of the first door 210 starts to increase.

Thus, the pillar 250 may be unfolded more reliably, and the first door 210 may rotate in the closing direction more smoothly without stopping until the first door 210 is closed completely.

In the above description, the setting of the operation transition timing of the damper assembly 500 and the unfolding timing of the pillar 250 are based on the angle formed by the front surface of the cabinet 100 and the first door 210, for example.

As another example, the setting of the operation transition timing of the damper assembly 500 and the unfolding timing of the pillar 250 are also based on a distance moved by the piston moving in the damper.

Thus, as illustrated in FIGS. 13 to 14 and 29 to 30, the piston 670 starts to move in the damper 600 from the damper contact timepoint P1 at a time of rotation of the first door 210 in the closing direction, such that the damper assembly 500 starts to provide a damping force.

While the piston 670 moves in the first inner diameter section A, the damper assembly 500 may operate based on the first damping operation and provide the first damping force.

In the case where the distance (hereinafter, “damper compression distance”) moved by the piston 670 moving as described above is a set distance or greater, the operation of the damper assembly 500 may transition from the first damping operation to the second damping operation, as illustrated in FIGS. 15, 29 and 31.

In this embodiment, in the case where the damper compression distance moved by the piston 670 from the damper contact timepoint P1 is the set distance or greater, the position of the piston 670 changes to the inner diameter change section B or the second inner diameter section C, for example.

That is, in the case where the piston 670 moves the set distance or greater after the piston 670 starts to move from the damper contact timepoint P1, the piston 670 may move in the inner diameter change section B or the second inner diameter section C, outside the first inner diameter section A.

In the case where the first door 210 continues to rotate in the closing direction in the state where the damper compression distance is the set distance or greater as describe above, the piston 670 may move in the second inner diameter section C, such that a damping force provided by the damper assembly 500 changes from the first damping force to the second damping force.

A timepoint when the damper compression distance is the set distance or greater (hereinafter, “set distance reaching timepoint”) may be a timing corresponding to the second set angle reaching timepoint P2.

The set distance reaching timepoint may be set to a timing very close to a third set distance reaching timepoint, while being set to a timing between a first set distance reaching timepoint and the third set distance reaching timepoint.

For example, the set distance reaching time may be set to be right before the third set angle reaching timepoint P3 or right after the third set angle reaching time P3 or simultaneous with the third set angle reaching timepoint P3.

Preferably, the set distance reaching timepoint may be set to be right before the third set angle reaching timepoint P3. Accordingly, right before the pillar 250 starts to be unfolded, the operation of the damper assembly 500 may transition from the first damping operation to the second damping operation.

Thus, the pillar 250 may be unfolded more reliably, and the first door 210 may rotate more smoothly in the closing direction, without stopping, until the first door 210 is closed completely.

As another example, the setting of the operation transition timing of the damper assembly 500 and the unfolding timing of the pillar 250 may be set based on the rotation speed of the door.

For example, the operation transition timing of the damper assembly 500 and the unfolding timing of the pillar 250 may be based on the angular speed of the first door 210 rotating in the closing direction.

Referring to FIGS. 28 and 30, in the case where the first door 210 rotates in the closing direction, a damping force does not act to the first door 210 until the damper contact timepoint.

Accordingly, in an initial rotation stage where the user stats to rotate the first door 210 by using a force, the angular speed of the first door 210 may increase rapidly. Additionally, the increased angular speed of the first door 210 may be maintained without decreasing in a section from the moment when the first door 210 starts to rotate in the closing direction until the damper contact timepoint P1.

From the damper contact timepoint P1, the damper assembly 500 may provide the first damping force while operating based on the first damping operation. That is, in the first section, the first damping force may be provided to the first door 210. Thus, in the first section, the angular speed of the first door 210 may decrease gradually, as illustrated in FIGS. 28, 30 and 34.

In the first section, the angular speed of the first door 210 may decrease in such a way that the angular speed of the first door 210 decreases rapidly (see FIGS. 28 and 34) or in such a way that the angular speed of the first door 210 decreases slowly for a longer period of time.

As the speed of the first door 210 decreases in the first section as described above, the first door 210 may rotate slower than previously rotated such that the first door 210 starts to be closed smoothly, in the first section.

At a timepoint when the first door 210 continues to rotate in the closing direction and the angular speed of the first door 210 becomes the set speed or less, the operation of the damper assembly 500 may transition from the first damping operation to the second damping operation, as illustrated in FIGS. 28, 29, 31 and 34.

In this embodiment, the set speed may be less than the angular speed of the first door 210 in the first section, and greater than a minimum speed required for the first door 210 to continue to rotate in the closing direction without stopping.

As an example, a time point, when the angular speed of the first door 210 becomes the set speed or less, may be a timing corresponding to the second set angle reaching timepoint P2.

As another example, the time point when the angular speed of the first door 210 becomes the set speed or less may be a timing corresponding to a timepoint when a compression distance of the damper starting to move from the damper contact timepoint P1 becomes a set distance, i.e., the set distance reaching timepoint.

Preferably, in the case where the angular speed of the first door 210 is between 0 and the set speed, the operation of the damper assembly 500 may transition from the first damping operation to the second damping operation.

As the operation of the damper assembly 500 is transitioned from the first damping operation to the second damping operation, the damping force acting to the first door 210 decreases from the first damping force to the second damping force, and accordingly, the angular speed of the first door 210 in the second damping operation of the damper assembly 500 may be faster than the angular speed of the first door 210 in the first damping operation of the damper assembly 500.

In this embodiment, as illustrated in FIGS. 28, 29, 32 and 34, the pillar 250 may start to be unfolded at a timing close to a timepoint when the angular speed of the first door 210 reaches the set speed.

A timepoint when the pillar 250 starts to be unfolded may be set to a timing very close to the timepoint when the angular speed of the first door 210 reaches the set speed, and may be set to be right before or right after the timepoint when the angular speed of the first door 210 reaches the set speed, or set to be simultaneous with the timepoint when the angular speed of the first door 210 reaches the set speed.

In this embodiment, the pillar 250 starts to be unfolded right after the timepoint when the angular speed of the first door 210 reaches the set speed, while the pillar 250 starts to be unfolded in the second section, for example.

Accordingly, in the case where the angular speed of the first door 210 is the set speed or greater, the pillar 250 may start to be unfolded. That is, at a timing when the rotation speed of the first door 210 starts to increase, the pillar 250 may start to be unfolded.

Thus, the pillar 250 may be unfolded more reliably, and the first door 210 may rotate more smoothly in the closing direction, without stopping, until the first door 210 is closed completely.

The embodiments are described above with reference to a number of illustrative embodiments thereof. However, the embodiments are provided as examples, and numerous other modifications and embodiments can be drawn by one having ordinary skill in the art from the embodiments. Thus, the technical scope of protection of the subject matter of the invention is to be defined according to the following claims.

What is claimed is:

1. A refrigerator, comprising:
a cabinet having a storage compartment;
a door rotatably connected to the cabinet to open and close the storage compartment; and
a damper configured to provide a damping force to resist the movement of door as the door rotates in a closing direction, the damping force including a first damping force having a first magnitude and a second damping force having a second magnitude that is less than the first magnitude,
wherein, as the door rotates in the closing direction, the damping force provided by the damper changes from the first damping force to the second damping force.

2. The refrigerator of claim 1, wherein the damper is configured to operate based on at least any one of a first damping operation to provide the first damping force and a second damping operation to provide the second damping force, and
wherein, as the door rotates in the closing direction, the first damping operation and the second damping operation are performed consecutively.

3. The refrigerator of claim 1, wherein, as the door rotates in the closing direction, the damping force provided by the damper changes from the first damping force to the second damping force at a timepoint when an angle formed by a front surface of the cabinet and the door becomes a set angle or less, or the damping force provided by the damper changes from the first damping force to the second damping force at a timepoint when an angular speed of the door becomes a set speed or less.

4. The refrigerator of claim 1, wherein the refrigerator further comprises a pillar foldably provided at the door, the pillar being configured to unfold while contacting the cabinet as the door closes the storage compartment, and
wherein, as the door rotates in the closing direction, the damping force provided by the damper changes from the first damping force to the second damping force at a timepoint when the pillar contacts the cabinet or the pillar is unfolded.

5. The refrigerator of claim 4, wherein the second magnitude of the second damping force is less than a magnitude of a third damping force that acts on the door as the pillar contacts the cabinet, or a total of the magnitude of the third damping force that acts on the door as the pillar contacts the cabinet and the second magnitude of the second damping force is equal to or less than the first magnitude of the first damping force.

6. The refrigerator of claim 1, wherein the damper is located at the door.

7. The refrigerator of claim 6, wherein the refrigerator further comprises a hinge assembly configured to rotatably connect the door to the cabinet, and
wherein the damper is configured to generate the damping force while being pressed by the hinge assembly.

8. The refrigerator of claim 1, wherein the damper is configured to operate based on at least any one of a first damping operation to provide the first damping force and a second damping operation to provide the second damping force,
wherein the damper includes:
a cylinder configured to accommodate fluid in an inner space thereof; and
a piston configured to compress the fluid while moving in the inner space of the cylinder to generate the damping force, and
wherein the damper is configured to transition between the first damping operation and the second damping operation based on a change in a position of the piston in the inner space of the cylinder.

9. The refrigerator of claim 8, wherein the inner space of the cylinder includes:
a first inner diameter section; and
a second inner diameter section, an inner diameter of the second inner diameter section being greater than an inner diameter of the first inner diameter section,
wherein, as the piston moves in the first inner diameter section, the damper is configured to operate based on the first damping operation, and
wherein, as the piston moves in the second inner diameter section, the damper is configured to operate based on the second damping operation.

10. The refrigerator of claim 1, wherein the damper is configured to operate based on at least any one of a first damping operation to provide the first damping force and a second damping operation to provide the second damping force, and
wherein, as the door rotates in the closing direction, the damper is configured to transition between the first damping operation and the second damping operation when an angle formed by a front surface of the cabinet and the door is a set angle or less.

11. The refrigerator of claim 10, wherein the damper is configured to:
operate based on the first damping operation when the door is in a first section that is a point at which the damper starts to operate and a point at which the angle between the front surface of the cabinet and the door is the set angle; and
operate based on the second damping operation when the door is in a second section that is between a point at which the door closes the storage compartment and the point at which the angle between the front surface of the cabinet and the door is the set angle.

12. The refrigerator of claim 11, wherein the refrigerator further comprises a pillar foldably provided at the door, the pillar being configured to unfold while contacting the cabinet while the door is in the second section.

13. The refrigerator of claim 12, wherein the pillar is configured to be unfolded at a timepoint when the angle formed by the front surface of the cabinet and the door becomes another set angle that is less than the set angle between the first section and the second section.

14. The refrigerator of claim 1, wherein the damper comprises:
a housing configured to accommodate fluid; and
a piston configured to compress the fluid while moving in the housing to generate the damping force,
wherein the damper is configured to operate based on at least any one of a first damping operation to provide the first damping force and a second damping operation to provide the second damping force, and
wherein, as the door rotates in the closing direction, the damper is configured to transition between the first damping operation and the second damping operation when a distance moved by the piston is a set distance or greater.

15. The refrigerator of claim 14, wherein an inner space of the housing includes:
a first inner diameter section; and
a second inner diameter section, an inner diameter of the second inner diameter section being greater than an inner diameter of the first inner diameter section,
wherein the first inner diameter section and the second inner diameter section are arranged along a direction in which the piston moves,
wherein, when the distance moved by the piston is less than the set distance, the piston moves in the first inner diameter section, and
wherein, when the distance moved by the piston is the set distance or greater, the piston moves in the second inner diameter section.

16. The refrigerator of claim 1, wherein the damper is configured to operate based on at least any one of a first damping operation to provide the first damping force and a second damping operation to provide the second damping force, and
wherein, as the door rotates in the closing direction, the damper is configured to transition between the first damping operation and the second damping operation when an angular speed of the door is a set speed or less.

17. The refrigerator of claim 1, wherein the refrigerator further comprises a pillar foldably provided at the door, the pillar being configured to unfold while contacting the cabinet as the door closes the storage compartment,
wherein the damper is configured to operate based on at least any one of a first damping operation to provide the first damping force and a second damping operation to provide the second damping force, and
wherein, as the door rotates in the closing direction, the damper is configured to transition between the first damping operation and the second damping operation in a set time range that includes a timepoint when the pillar contacts the cabinet or when the pillar is unfolded.

18. The refrigerator of claim 17, wherein the damper is configured to transition from the first damping operation to the second damping operation before the timepoint when the pillar contacts the cabinet or when the pillar is unfolded.

19. The refrigerator of claim 17, wherein the damper is configured to operate based on the first damping operation by contacting the door rotating in the closing direction, and then to operate based on the second damping operation before the timepoint when the pillar contacts the cabinet or when the pillar is unfolded.

20. The refrigerator of claim 17, wherein, when at least any one of a condition under which an angle formed by a front surface of the cabinet and the door is a set angle or less, a condition under which an angular speed is a set speed or less, and a condition under which a distance moved by a piston compressing fluid in a housing of the damper is a set distance or greater is satisfied, the damper is configured to transition from the first damping operation to the second damping operation.
